(19) United States
(12) Patent Application Publication
(10) Pub. No.: US 2016/0091772 A1
(43) Pub. Date: Mar. 31, 2016

(54) OPTICAL MODULATOR AND IMAGE DISPLAY APPARAUTS

(71) Applicant: Seiko Epson Corporation, Tokyo (JP)

(72) Inventor: Junichi OKAMOTO, Fujimi (JP)

(21) Appl. No.: 14/867,320

(22) Filed: Sep. 28, 2015

(30) Foreign Application Priority Data
Sep. 30, 2014 (JP) 2014-202402

(51) Int. Cl. G02F 1/225; G09G 3/02; G09G 3/00; G02B 27/01

(52) U.S. Cl. CPC G02F 1/225; G02B 27/0103; G09G 3/02; G09G 3/003; G02F 2001/212

(57) ABSTRACT

An optical modulator includes: an optical waveguide that is constituted by a material having an electro-optical effect; a wavelength selector that is provided to the optical waveguide, and selects a wavelength of a light beam that is guided through the optical waveguide; and an optical modulator that is provided to the optical waveguide, and modulates intensity of a light beam with a wavelength selected by the wavelength selector, wherein the wavelength selector includes, a first electric field applicator that is capable of forming a first refractive index distribution in which a refractive index periodically varies in a first period along an optical wave-guiding direction of the optical waveguide, and a second electric field applicator that is capable of forming a second refractive index distribution in which a refractive index periodically varies in a second period different from the first period along the optical wave-guiding direction of the optical waveguide.

### BACKGROUND

1. Technical Field

The present invention relates to an optical modulator and an image display apparatus.

2. Related Art

As one of an image display technology of a head-mounted display (HMD) or a head-up display (HUD), recently, a display apparatus, which directly irradiates the retina of the eye with a laser so as to allow a user to visually recognize an image, has attracted attention.

Typically, the display apparatus includes a light emitting device that emits a light beam, and a scanning unit that changes the light beam path in order for the retina of the user to be scanned with the light beam that is emitted. In addition, according to this display apparatus, the user can simultaneously visually recognize, for example, both of an outside landscape and an image that is drawn by the scanning unit.

JP-A-2012-022233 discloses a Mach-Zehnder interferometer which allows a plurality of light beams with wavelengths different from each other to be sequentially incident thereto and is capable of modulating the intensity for each wavelength. In this interferometer, a bias voltage is variably controlled in order for the intensity of the emitted light beam to enter a predetermined permissible range for each wavelength. According to this, even when a plurality of light beams with wavelengths different from each other are sequentially incident to one interferometer, it is possible to prevent a deviation from occurring in modulation characteristics for each wavelength.

In addition, JP-T-2009-516862 discloses an image generator (head-up display) including a light source, a light beam coupler, a beam scanner capable of operating for scanning with the light beam in a two-dimensional pattern, and a guide substrate which receives the light beam that is scanned and emits the light beam from an output position to a visible region. In addition, JP-A-2012-022233 discloses a configuration in which as the light source, a DPSS laser such as an acousto-optical modulator (AOM) using external modulation is employed (paragraph [0026] in JP-A-2012-022233). In addition, an output of laser light which is emitted from each of a red laser light source, a blue laser light source, and a green laser light source is modulated so as to display an arbitrary image on the retina.

However, in the interferometer described in JP-A-2012-022233, with regard to the light source from which a light beam is incident to the interferometer, a configuration of using a light source having a structure, in which an emission light beam is selectively emitted for each wavelength, is disclosed. When using such a light source, it is possible to realize exclusive intensity modulation on the time axis for each wavelength.

JP-A-2012-022233 discloses the light source having the structure in which the emission light beam is selectively emitted for each wavelength, and examples thereof includes a light source provided with a plurality of fixed-wavelength light sources with wavelengths different from each other, and an optical switch through which emission light beams of the light sources are selectively transmitted without overlapping with each other on the time axis. In this light source, high alignment accuracy is demanded for connection between the plurality of fixed-wavelength light sources and the optical switch. According to this, manufacturing of a display, which includes a light source, a wavelength selection unit such as an optical switch, and an intensity modulation unit such as Mach-Zehnder interferometer, is accompanied with much difficulty. In addition, in a case where an apparatus is constituted by a plurality of different optical components, a loss at respective portions which are optically connected is accumulated, and thus there is a concern that the entire efficiency may greatly decrease. In addition, alignment deviation is likely to occur, and thus it can be considered that an optical loss is likely to occur. According to this, when using the modulator in a display apparatus, a deficiency in an amount of a light beam may be caused in a display image, or in a case of raising output power of a light source so as to compensate the deficiency in the amount of a light beam, there is a concern that power consumption increases.

In the above-described display device, it is necessary to conduct conversion of a wavelength at a very high speed so as to form an image with a high quality. However, currently, in the light source, a speed of converting a wavelength of the emission light beam is not sufficient, and thus the conversion of the wavelength does not follow a scanning speed of a light beam. Accordingly, it is difficult to form an image with a high quality.

### SUMMARY

An advantage of some aspects of the invention is to provide an optical modulator which has high light utilization efficiency and is capable of conducting modulation for each of a plurality of wavelengths different from each other, and an image display apparatus which includes the optical modulator, and is capable of displaying an image with a high quality.

The advantage is accomplished by the following aspects of the invention.

An optical modulator according to an aspect of the invention includes: an optical waveguide that is constituted by a material having an electro-optical effect; a wavelength selection unit that is provided to the optical waveguide, and selects a wavelength of a light beam that is guided through the optical waveguide; and an optical modulation unit that is provided to the optical waveguide, and modulates intensity of a light beam with a wavelength selected by the wavelength selection unit. The wavelength selection unit includes a first electric field application unit that is capable of forming a first refractive index distribution in which a refractive index periodically varies in a first period along an optical wave-guiding direction of the optical waveguide, and a second electric field application unit that is capable of forming a second refractive index distribution in which a refractive index periodically varies in a second period different from the first period along the optical wave-guiding direction of the optical waveguide.

According to this configuration, the wavelength selection unit is constituted by electric field application units which include an electrode that is arranged along the optical wave-guiding direction of the optical waveguide, and the like, and the optical modulation unit is also provided to the optical waveguide, and thus it is not necessary to provide an optical connection site between the wavelength selection unit and the optical modulation unit. As a result, alignment, in which consideration into an optical path length is strictly taken, is not necessary, and the connection site is not provided, and thus an optical loss is not likely to occur. Accordingly, light utilization efficiency of the optical modulator becomes high. In addition, the first electric field application unit and the second electric field application unit are provided, and thus it is possible to easily select a wavelength of a light beam that is transmitted through the wavelength selection unit. Accordingly, it is possible to obtain an optical modulator capable of modulating a plurality of light beams with wavelength different from each other.

In the optical modulator according to the aspect of the invention, it is preferable that the first electric field application unit is provided with an interval corresponding to the first period, and includes an electrode capable of applying a voltage to the optical waveguide, and the second electric field application unit is provided with an interval corresponding to the second period, and includes an electrode capable of applying a voltage to the optical waveguide.

According to this configuration, when the first period and the second period are set to be different from each other, it is possible to make a wavelength of a light beam that is reflected in the first electric field application unit and a wavelength of a light beam that is reflected in the second electric field application unit different from each other in a simple and accurate manner. In addition, it is possible to increase selectivity of a wavelength of a light beam that is reflected.

In the optical modulator according to the aspect of the invention, it is preferable that the electrode of the first electric field application unit includes a first inter-digital electrode that includes a plurality of first electrodes, and a connection portion that connects the plurality of first electrodes to each other, and a second inter-digital electrode that includes a plurality of second electrodes, and a connection portion that connects the plurality of second electrodes to each other.

According to this configuration, it is possible to realize simplification of an electrode structure and a reduction in a wiring length for connection between an electrode and an external power supply.

In the optical modulator according to the aspect of the invention, it is preferable that the electrode of the first electric field application unit has an elongated portion in a plan view, and a longitudinal direction of the elongated portion intersects the optical wave-guiding direction of the optical waveguide.

According to this configuration, it is possible to reflect a light beam with a specific wavelength due to the first refractive index distribution that occurs in the optical waveguide in accordance with a potential that is applied to the electrode of the first electric field application unit, and thus it is possible to select a wavelength of a transmitting light beam.

In the optical modulator according to the aspect of the invention, it is preferable that the longitudinal direction and the optical wave-guiding direction are not perpendicular to each other.

According to this configuration, a light beam, which is reflected by the first refractive index distribution that occurs in the optical waveguide in accordance with the potential that is applied to the electrode of the first electric field application unit, is prevented from returning to a light source, and thus it is possible to prevent an operation of the light source from being unstable or it is possible to prevent the reflected light beam from being a so-called stray light beam and from being mixed in a signal light beam.

In the optical modulator according to the aspect of the invention, it is preferable that the first refractive index distribution is formed to reflect a light beam that is guided through the optical waveguide, and the wavelength selection unit further includes an optical absorption unit that absorbs a light beam that is reflected with the first refractive index distribution.

According to this configuration, it is possible to trap a light beam, which is reflected with the first refractive index distribution, inside the optical absorption unit. Accordingly, it is possible to prevent the light beam from returning to the optical waveguide again, or it is possible to prevent the light beam from being emitted from an emission end and being a stray light beam.

In the optical modulator according to the aspect of the invention, it is preferable that the first refractive index distribution is formed to reflect a light beam that is guided through the optical waveguide, and the wavelength selection unit further includes an optical detection unit that detects an amount of a light beam that is reflected with the first refractive index distribution.

According to this configuration, it is possible to confirm whether or not the light beam is reliably reflected with the first refractive index distribution. In addition, it is possible to conduct feedback for appropriate adjustment of the magnitude of a voltage that is applied to the first electric field application unit or an application timing of the voltage on the basis of data relating to an amount of a light beam that is reflected.

In the optical modulator according to the aspect of the invention, it is preferable that the material having the electro-optical effect is lithium niobate.

Lithium niobate has a relatively large electro-optical coefficient. Accordingly, it is possible to lower a drive voltage during selection of a wavelength of a transmitting light beam in the wavelength selection unit, and it is also possible to lower a drive voltage during modulation of intensity of a light beam in the optical modulation unit. According to this, it is possible to reduce power consumption of the optical modulator. In addition, it is possible to reduce an area, which is necessary for the wavelength selection unit or the optical modulation unit to achieve a function thereof, and thus it is possible to realize a reduction in size of the optical modulator.

In the optical modulator according to the aspect of the invention, it is preferable that the optical modulation unit is a Mach-Zehnder type optical modulation unit.

According to this configuration, high-speed modulation is possible, and thus it is possible to realize a high quality of an image that is displayed.

In the optical modulator according to the aspect of the invention, it is preferable that the optical waveguide includes a plurality of core portions which are connected to an incident surface from which a light beam is incident to the optical waveguide, and a multiplexing unit that multiplexes the plurality of core portions and connects the plurality of core portions to the wavelength selection unit.

According to this configuration, the multiplexing unit, the wavelength selection unit, and the optical modulation unit are provided to the same member, and thus it is possible to realize a reduction in size of the optical modulator in comparison to a case where these units are configured as an independent member. In addition, it is possible to reduce an optical coupling loss between the respective units, and thus it is possible suppress an internal loss of the optical modulator.

An optical modulator according to another aspect of the invention includes: an optical waveguide that is constituted by a material having an electro-optical effect; a wavelength selection unit that is provided to the optical waveguide, and selects a wavelength of a light beam that is guided through the optical waveguide; and an optical modulation unit that is provided to the optical waveguide, and modulates intensity of a light beam with a wavelength selected by the wavelength selection unit. The wavelength selection unit includes a first reflective unit that is capable of reflecting a light beam with a first wavelength, which is guided through the optical waveguide, by using Bragg reflection, and a second reflective unit that is capable of reflecting a light beam with a second wavelength different from the first wavelength, which is guided through the optical waveguide, by using the Bragg reflection.

According to this configuration, the wavelength selection unit is constituted by the first reflection unit and the second reflection unit which are capable of reflecting a light beam, which is guided through the optical waveguide, by using Bragg reflection, and the optical modulation unit is also provided to the optical waveguide, and thus it is not necessary to provide an optical connection site between the wavelength selection unit and the optical modulation unit. As a result, alignment, in which consideration into an optical path length is strictly taken, is not necessary, and the connection site is not provided, and thus an optical loss is not likely to occur. Accordingly, light utilization efficiency of the optical modulator becomes high. In addition, the first reflection unit and the second reflection unit are provided, and thus it is possible to easily select a wavelength of a light beam that is transmitted through the wavelength selection unit. Accordingly, it is possible to obtain an optical modulator capable of modulating a plurality of light beams with wavelength different from each other.

An image display apparatus according to still another aspect of the invention includes: a light source unit that emits a light beam with a first wavelength which is reflected with a first refractive index distribution, and a light beam with a second wavelength which is reflected with a second refractive index distribution; the optical modulator according to the aspect of the invention to which the light beam with the first wavelength and the light beam with the second wavelength are incident; and an optical scanner that performs spatial scanning with a light beam modulated by the optical modulator.

According to this configuration, it is possible to obtain an image display apparatus capable of displaying an image with a high quality.

In the image display apparatus according to the aspect of the invention, it is preferable that wherein in a first period of time, the wavelength selection unit is driven in order for the second refractive index distribution to be formed, and the optical modulation unit is driven to modulate intensity of a light beam with the first wavelength which is transmitted through the wavelength selection unit, and in a second period of time different from the first period of time, the wavelength selection unit is driven in order for the first refractive index distribution to be formed, and the optical modulation unit is driven to modulate intensity of a light beam with the second wavelength which is transmitted through the wavelength selection unit.

According to this configuration, in the optical modulation unit, it is possible to conduct intensity modulation of light beams with wavelength different from each other in a time-division manner, and thus it is possible to conduct accurate intensity modulation.

In the image display apparatus according to the aspect of the invention, it is preferable that during transition from the first period of time to the second period of time, in a period of time between the first period of time and the second period of time, the wavelength selection unit is driven to reflect both the light beam with the first wavelength and the light beam with the second wavelength.

According to this configuration, in the period of time between the first period of time and the second period of time, both the light beam with the first wavelength and the light beam with the second wavelength are not transmitted through the wavelength selection unit, and thus the first period of time and the second period of time are prevented from overlapping with each other. As a result, it is possible to prevent an image quality of an image displayed by the image display apparatus deteriorating.

An image display apparatus according to yet another aspect of the invention includes: a light source unit that emits a light beam with a first wavelength, and a light beam with a second wavelength; the optical modulator according to the aspect of the invention to which the light beam with the first wavelength and the light beam with the second wavelength are incident; and an optical scanner for spatial scanning with a light beam that is modulated by the optical modulator.

According to this configuration, it is possible to obtain an image display apparatus capable of displaying an image with a high quality.

In the image display apparatus according to the aspect of the invention, it is preferable that a reflective optical unit that reflects a light beam used for scanning by the optical scanner, and the reflective optical unit includes a holographic diffraction grating.

According to this configuration, it is possible to adjust an emission direction of a light beam that is reflected by the reflective optical unit, or it is possible to select a wavelength of a light beam that is reflected.

### BRIEF DESCRIPTION OF THE DRAWINGS

The invention will be described with reference to the accompanying drawings, wherein like numbers reference like elements.

FIG. 1 is a view illustrating a schematic configuration of a first embodiment (head-mounted display) of an image display apparatus according to the invention.

FIG. 2 is a partially enlarge view of the image display apparatus illustrated in FIG. 1.

FIG. 3 is a schematic configuration view of a signal generation unit of the image display apparatus illustrated in FIG. 1.

FIG. 4 is a view illustrating a schematic configuration of an optical scanning unit that is included in a scanning light beam emitting unit illustrated in FIG. 1.

FIG. 5 is a view schematically illustrating an operation of the image display apparatus illustrated in FIG. 1.

FIG. 6 is a perspective view illustrating a schematic configuration of an optical modulator (a first embodiment of an optical modulator according to the invention) illustrated in FIG. 3.

FIG. 7 is a plan view of the optical modulator illustrated in FIG. 6.

FIG. 8A is a partially enlarged view of a first electric field application unit illustrated in FIG. 7 and illustrates a state in which an electric field is applied to an optical waveguide from the first electric field application unit, and FIG. 8B is a partially enlarged view of the first electric field application unit illustrated in FIG. 7 and illustrates a state in which an electric field is not applied to the optical waveguide from the first electric field application unit.

FIG. 9 is a cross-sectional view when cutting a core portion in FIG. 8A along a longitudinal direction.

FIG. 10A is a partially enlarged view of a second electric field application unit illustrated in FIG. 7 and illustrates a state in which an electric field is applied to an optical waveguide from the second electric field application unit, and FIG. 10B is a partially enlarged view of a third electric field application unit illustrated in FIG. 7 and illustrates a state in which an electric field is applied to the optical waveguide from the third electric field application unit.

FIG. 11 is a view illustrating an example of a time transition (timing chart) of a voltage application pattern for driving the first electric field application unit, the second electric field application unit, and the third electric field application unit, and a color of a light beam that is transmitted through a wavelength selection unit at that time.

FIG. 12 is a view illustrating another configuration example of each inter-digital electrode.

FIG. 13 is a partially enlarged plan view of a wavelength selection unit that is included in an optical modulator according to a second embodiment.

FIGS. 14A and 14B are partially enlarged plan views of the wavelength selection unit that is included in the optical modulator according to the second embodiment.

FIG. 15 is a cross-sectional view of a wavelength selection unit that is included in an optical modulator according to a third embodiment.

FIG. 16 is a view illustrating a fourth embodiment (head-up display) of the image display apparatus according to the invention.

### DESCRIPTION OF EXEMPLARY EMBODIMENTS

Hereinafter, an optical modulator and an image display apparatus according to the invention will be described in detail with reference to appropriate embodiments illustrated in the accompanying drawings.

### Image Display Apparatus

### First Embodiment

Description will be given of a first embodiment of the image display apparatus according to the invention, and a first embodiment of the optical modulator according to the invention.

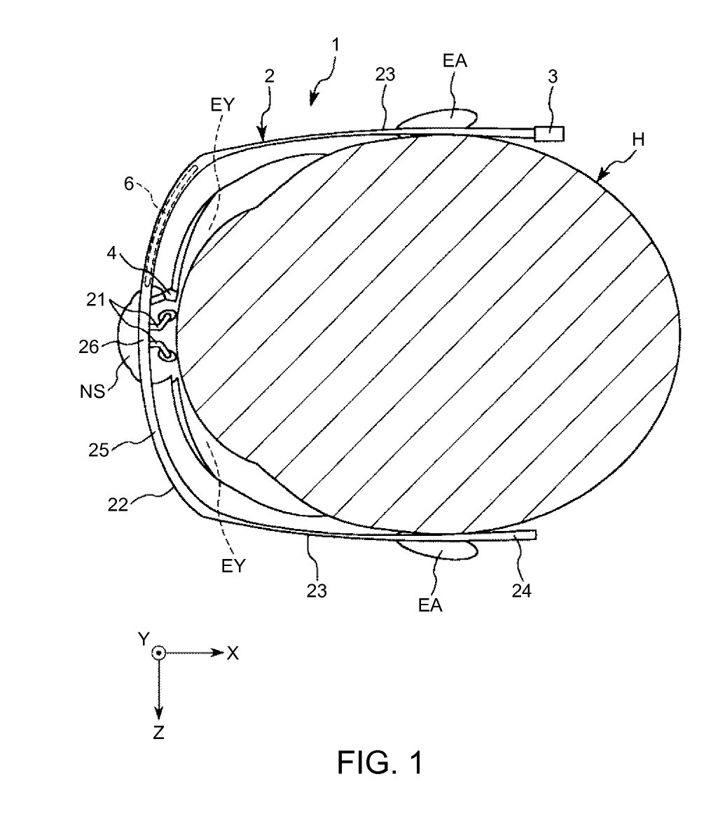

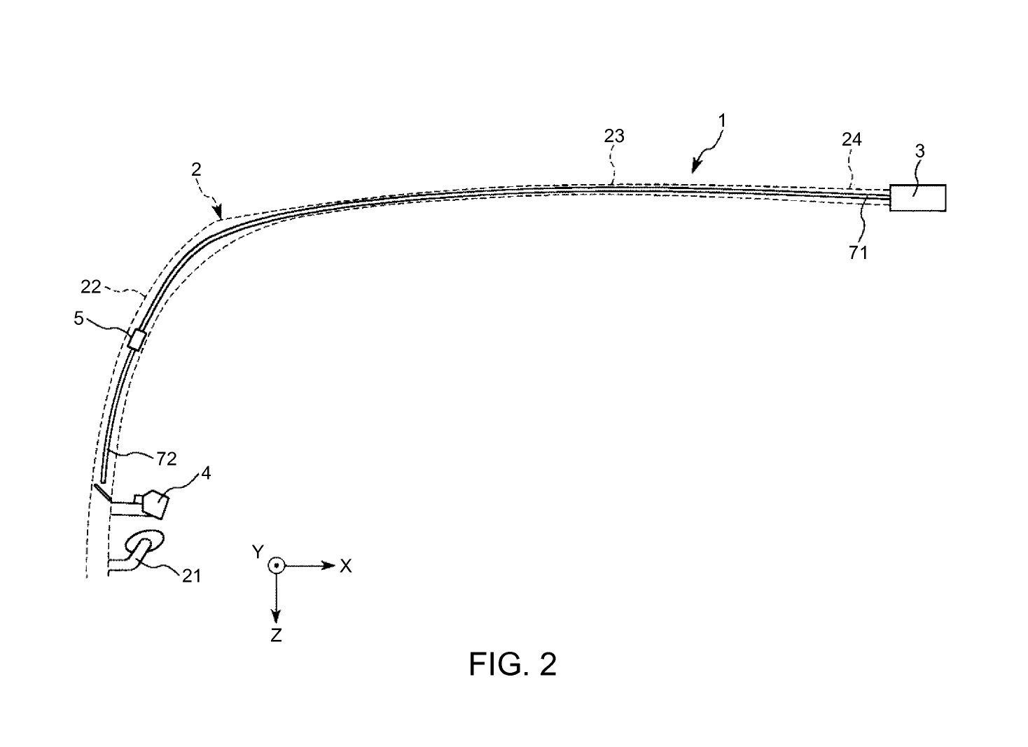

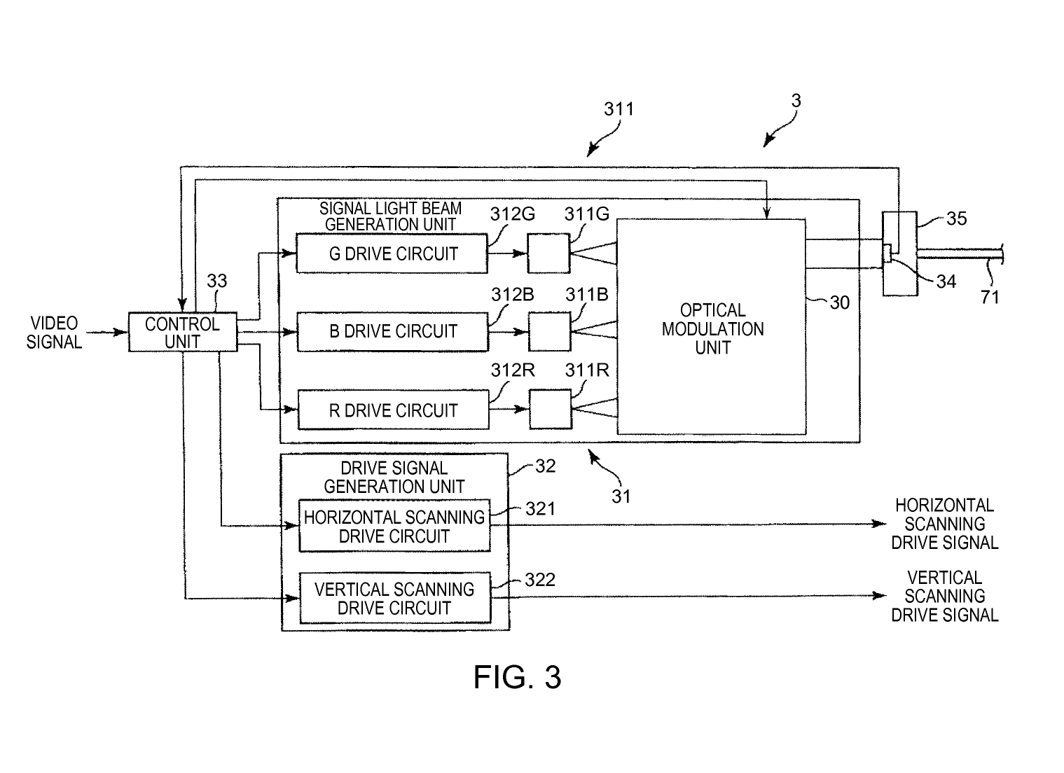

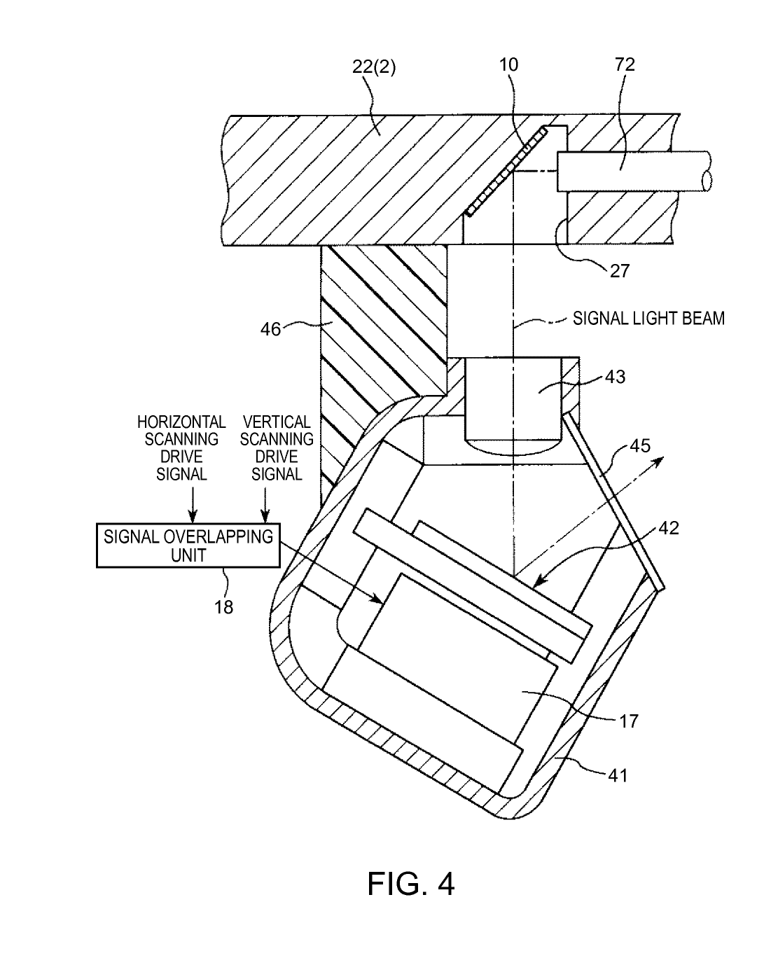

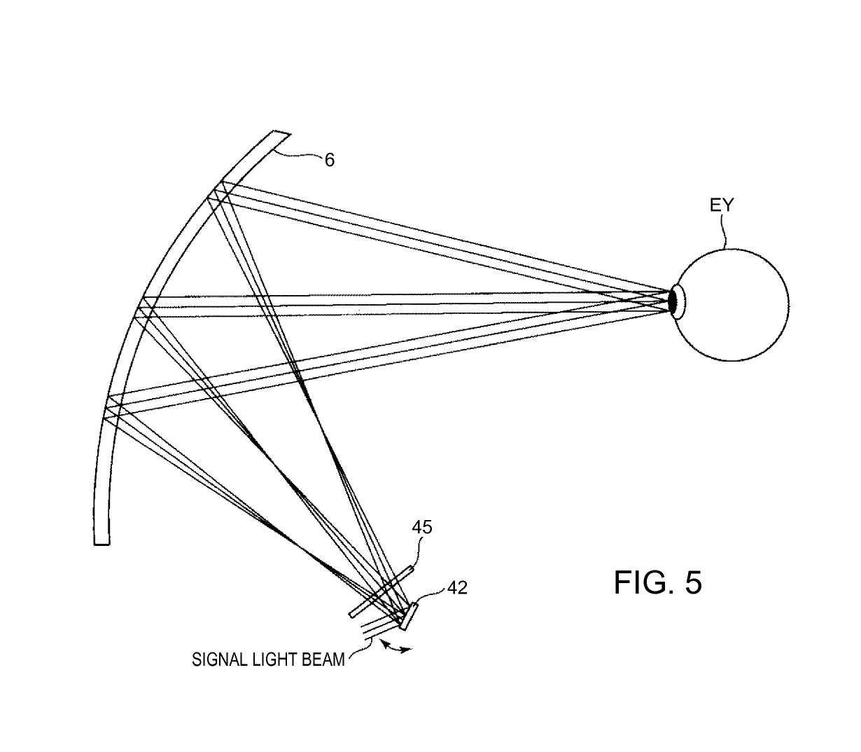

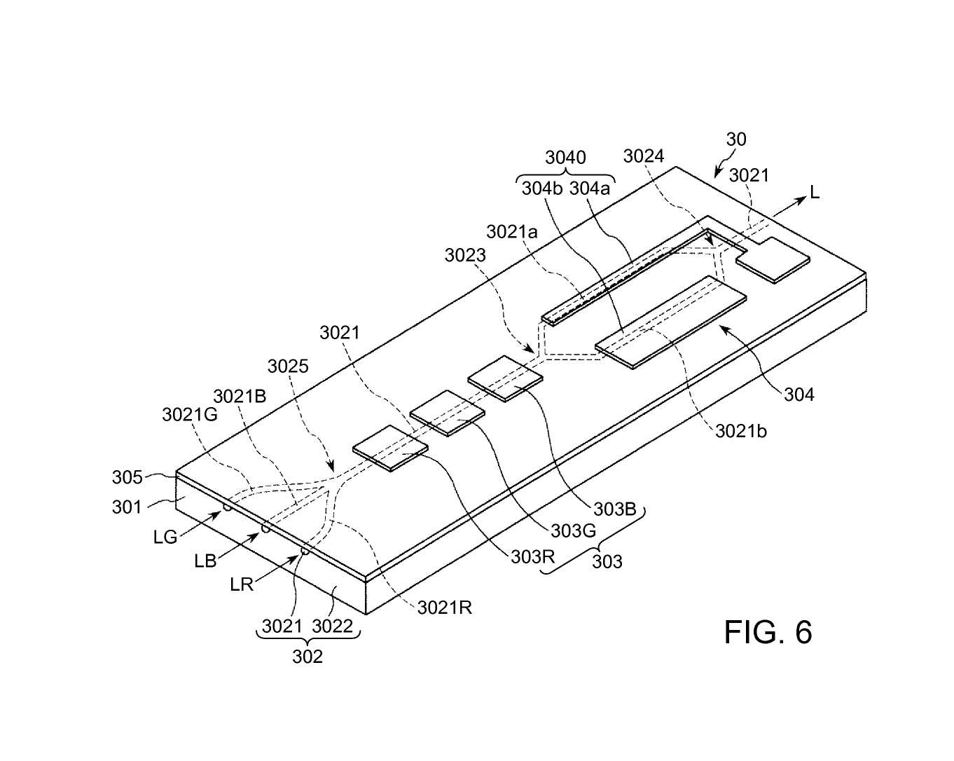

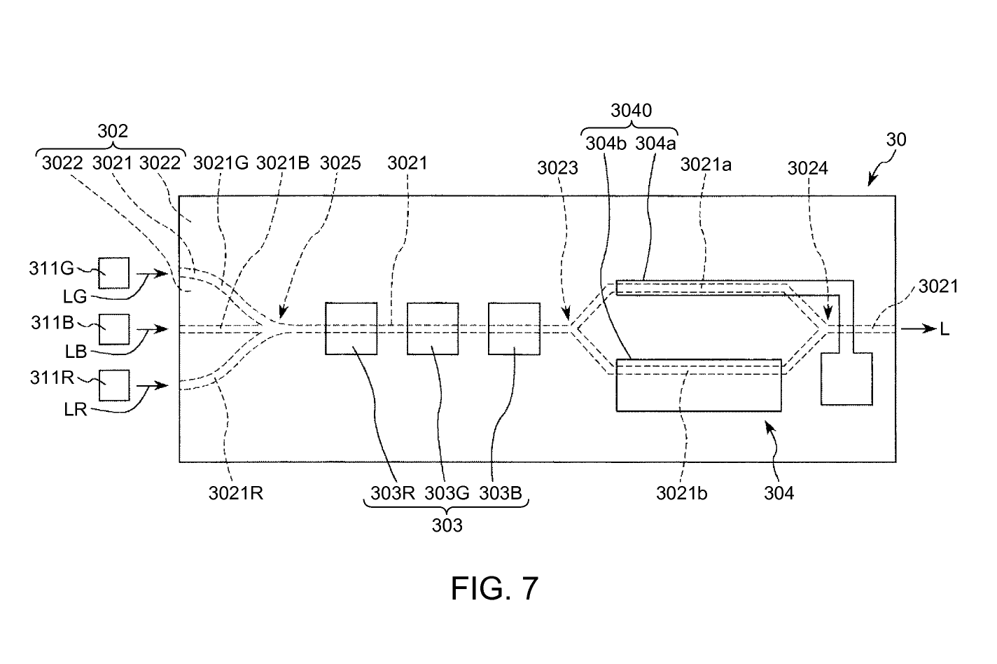

FIG. 1 is a view illustrating a schematic configuration of the first embodiment (head-mounted display) of the image display apparatus according to the invention, and FIG. 2 is a partially enlarge view of the image display apparatus illustrated in FIG. 1. FIG. 3 is a schematic configuration view of a signal generation unit of the image display apparatus illustrated in FIG. 1, FIG. 4 is a view illustrating a schematic configuration of an optical scanning unit that is included in a scanning light beam emitting unit illustrated in FIG. 1, FIG. 5 is a view schematically illustrating an operation of the image display apparatus illustrated in FIG. 1, FIG. 6 is a perspective view illustrating a schematic configuration of an optical modulator (a first embodiment of the optical modulator according to the invention) illustrated in FIG. 3, and FIG. 7 is a plan view of the optical modulator illustrated in FIG. 6.

In FIG. 1, for convenience of explanation, an X-axis, a Y-axis, and a Z-axis are illustrated as three axes which are perpendicular to each other, and a front end side and a base end side of an arrow that is illustrated are set as “+ (positive)” and “− (negative)”, respectively. A direction parallel to the X-axis is referred to as an “X-axis direction”, a direction parallel to the Y-axis is referred to as a “Y-axis direction, and a direction parallel to the Z-axis is referred to as a “Z-direction”.

Here, the X-axis, the Y-axis, and the Z-axis are set in such a manner that when the following image display apparatus 1 is mounted on the head H of a user, the Y-axis direction becomes an upper and lower direction of the head H, the Z-axis direction becomes a right and left direction of the head H, and the X-axis direction becomes a front and rear direction of the head H.

As illustrated in FIG. 1, the image display apparatus 1 of this embodiment is a head-mounted display (head-mounted image display apparatus) having an external appearance similar to eyeglasses. The image display apparatus 1 is used in a state of being mounted on the head H, and allows a user to visually recognize an image that is a virtual image in a state in which the image overlaps with an external image.

As illustrated in FIG. 1, the image display apparatus 1 includes a frame 2, a signal generation unit 3, a scanning light beam emitting unit 4, and a reflection unit 6.

As illustrated in FIG. 2, the image display apparatus 1 includes a first optical fiber 71, a second optical fiber 72, and a connection unit 5.

In the image display apparatus 1, the signal generation unit 3 generates a signal light beam that is modulated in accordance with image information, the signal light beam is guided to the scanning light beam emitting unit 4 through the first optical fiber 71, the connection unit 5, and the second optical fiber 72, the scanning light beam emitting unit 4 conducts two-dimensional scanning with the signal light beam (video light beam) and emits the scanning light beam, and the reflection unit 6 reflects the scanning light beam toward the eye EY of a user. According to this, a virtual image in accordance with image information can be visually recognized to the user.

In this embodiment, description will be given of an example in which the signal generation unit 3, the scanning light beam emitting unit 4, the connection unit 5, the reflection unit 6, the first optical fiber 71, and the second optical fiber 72 are provided only on a right side of the frame 2, and only a virtual image for the right eye is formed. However, the left side of the frame 2 may be configured in the same manner as the right side and a virtual image for the left eye may be formed in combination with the virtual image for the right eye, or only the virtual image for the left eye may be formed.

In addition, a unit that optically connects the signal generation unit 3 and the scanning light beam emitting unit 4 may be substituted with a unit utilizing, for example, a light guide body in addition to the unit utilizing the optical fiber. In addition, the first optical fiber 71 and the second optical fiber 72 may be connected without through the connection unit 5, and the signal generation unit 3 and the scanning light beam emitting unit 4 may be optically connected only with the first optical fiber 71 without through the connection unit 5.

Hereinafter, respective portions of the image display apparatus 1 will be sequentially described in detail.

### Frame

As illustrated in FIG. 1, the frame 2 has a shape similar to an eyeglass frame, and has a function of supporting the signal generation unit 3 and the scanning light beam emitting unit 4.

As illustrated in FIG. 1, the frame 2 includes a front portion 22 that supports the scanning light beam emitting unit 4 and a nose pad portion 21, a pair of temple portions (hanging portion) 23 which is connected to the front portion 22 and comes into contact with the ear of the user, and a modern portion 24 that is an end opposite to the front portion 22 of each of the temple portions 23.

The nose pad portion 21 comes into contact with the nose NS of the user during use and supports the image display apparatus 1 to the head of the user. The front portion 22 includes a rim portion 25 or a bridge portion 26.

The nose pad portion 21 has a configuration capable of adjusting a position of the frame 2 with respect to the user during use.

The shape of the frame 2 is not limited to a shape illustrated as long as the frame 2 is capable of being mounted on the head H of the user.

### Signal Generation Unit

As illustrated in FIG. 1, the signal generation unit 3 is provided to the modern portion 24 (end on a side opposite to the front portion 22 of the temple portion 23) on one side (on a right side in this embodiment) of the above-described frame 2.

That is, the signal generation unit 3 is disposed on a side opposite to the eye EY on the basis of the ear EA of the user during use. According to this, it is possible to allow the image display apparatus 1 to have an excellent weight balance.

As described below, the signal generation unit 3 has both a function of generating a signal light beam that is used for scanning conducted by the optical scanning unit 42 of the following scanning light beam emitting unit 4, and a function of generating a drive signal that drives the optical scanning unit 42.

As illustrated in FIG. 3, the signal generation unit includes an optical modulator 30, a signal light beam generating unit 31, a drive signal generation unit 32, a control unit 33, an optical detection unit 34, and a fixing unit 35.

As described below, the signal light beam generating unit 31 generates a signal light beam that is used for scanning (optical scanning) conducted by the optical scanning unit 42 (optical scanner) of the following scanning light beam emitting unit 4.

The signal light beam generating unit 31 includes a plurality of light sources 311R, 311G, and 311B with wavelengths different from each other, and a plurality of drive circuits 312R, 312G, and 312B.

The light source 311R (R light source) emits a red light beam, the light source 311G (G light source) emits a green light beam, and the light source 311B (B light source) emits a blue light beam. When using the three colors of light beams, it is possible to display a full color image. In a case where a full color image is not displayed, a monochromatic light beam or two colors of light beams (one or two light sources) may be used, and four or more colors of light beams (four or more light sources) may be used to enhance color rendering properties of a full color image.

The light sources 311R, 311G, and 311B are not particularly limited, and for example, a laser diode, and an LED can be used.

The light sources 311R, 311G, and 311B are electrically connected to the drive circuits 312R, 312G, and 312B, respectively.

Hereinafter, the light sources 311R, 311G, and 311B are collectively referred to as a “light source unit 311”, and a signal light beam that is generated in the signal light beam generating unit 31 is referred to as a “light beam that is emitted from the light source unit 311”.

The drive circuit 312R has a function of driving the above-described light source 311R, the drive circuit 312G has a function of driving the above-described light source 311G, and the drive circuit 312B has a function of driving the above-described light source 311B.

Three (three colors of) light beams, which are emitted from the light sources 311R, 311G, and 311B which are driven by the drive circuits 312R, 312G, and 312B, respectively, are incident to the optical modulator 30.

### Optical Modulator

The optical modulator 30 illustrated in FIG. 6 includes a substrate 301, an optical waveguide 302 that is formed in the substrate 301, a wavelength selection unit 303 that is provided to the optical waveguide 302 and has a function of selecting a wavelength of a light beam that is guided through the optical waveguide 302, an optical modulation unit 304 that is provided to the optical waveguide 302 and has a function of modulating intensity of a light beam with a wavelength that is selected by the wavelength selection unit 303, electric field application units 303R, 303G, and 303B which are provided to the substrate 301 and the wavelength selection unit 303, and a buffer layer 305 that is interposed between electrodes 304a and 304b which are provided to the optical modulation unit 304.

The substrate 301 has a rectangular flat sheet shape in a plan view, and is constituted by a material having an electro-optical effect. The electro-optical effect is a phenomenon in which a refractive index of a material varies when an electric field is applied to the material, and examples of the electro-optical effect include a Pockels effect in which the refractive index is proportional to the electric field, and a Kerr effect in which the refractive index is proportional to the square of the electric field. When the optical waveguide 302 that is diverged partway along the substrate 301 is formed in the substrate 301, and an electric field is applied to one side of the optical waveguide 302 that is diverged, it is possible to change the refractive index. When using this phenomenon, if a phase difference is applied to a light beam that propagates through the optical waveguide 302 that is diverged, and light beams which are diverged are joined again, it is possible to conduct intensity modulation on the basis of the phase difference.

Examples of the material having the electro-optical effect include inorganic materials such as lithium niobate (LiNbO₃), lithium tantalate (LiTaO₃), lead lanthanum zirconate titanate (PLZT), and potassium titanate phosphate (KTiOPO₄), polythiophene, a liquid crystal material, organic materials such as a material in which an electro-optically active polymer is doped with a charge transport molecule, a material in which a charge transporting polymer is doped with an electro-optical pigment, a material in which an inactive polymer is doped with a charge transport molecule and an electro-optical pigment, a material including a charge transport portion and an electro-optical portion at a main chain or a side chain of a polymer, and a material doped with tricyanofurane (TCF) as an acceptor, and the like.

Among these, particularly, lithium niobate is preferably used. Lithium niobate has a relatively large electro-optical coefficient, and thus during selection of a wavelength of a transmitting light beam in the following wavelength selection unit 303, it is possible to lower a drive voltage, and it is possible to shorten an operation distance. As a result, during the following modulation of intensity of a light beam in the optical modulation unit 304, it is also possible to lower a drive voltage, and it is possible to shorten an operation distance. According to this, it is possible to reduce power consumption of the optical modulator 30 and the image display apparatus 1. In addition, it is possible to reduce an area, which is necessary for the wavelength selection unit 303 or the optical modulation unit 304 to achieve a function thereof, and thus it is possible to realize a reduction in size of the optical modulator 30 and the image display apparatus 1.

It is preferable that the materials are used as a single crystal or a solid-solution crystal. According to this, a light-transmitting property is given to the substrate 301, and thus it is possible to form the optical waveguide 302 in the substrate 301.

The optical waveguide 302 is a light guiding path that is formed in the substrate 301. Examples of a method of forming the optical waveguide 302 in the substrate 301 include a proton exchange method, a Ti diffusion method, and the like.

Among these methods, the proton exchange method is a method in which a substrate is immersed in an acid solution, protons are intruded into the substrate through elution and exchange of ions, thereby changing a refractive index of a region into which the protons are intruded. According to this method, particularly, an optical waveguide 302, which is particularly excellent in light resistance, is obtained. On the other hand, the Ti diffusion method is a method in which after Ti is formed on the substrate, and a heating treatment is carried out to diffuse Ti into the substrate, thereby changing a refractive index of a region into which Ti is diffused.

The optical waveguide 302, which is formed as described above, includes a core portion 3021 that is constituted by an elongated portion having a relatively high refractive index in the substrate 301, and a clad portion 3022 that is adjacent to the core portion 3021 and has a relative low refractive index. In the optical waveguide 302 illustrated in FIG. 7, when a light beam is incident to an end (incident surface) on a left side in FIG. 7, the incident light beam propagates toward a right side while being repetitively reflected on an interface between the core portion 3021 and the clad portion 3022, and is emitted as emission light beam L from an end on a right side. That is, the core portion 3021 can be substantially regarded as the optical waveguide 302.

The core portion 3021 includes three core portions 3021R, 3021G, and 3021B which have incident surfaces (are connected to the incident surfaces), respectively. Light beams, which are emitted from the light sources 311R, 311G, and 311B, are incident to the incident surfaces of the three core portion 3021R, 3021G, and 3021B, respectively.

In addition, among the three core portions 3021R, 3021G, and 3021B, the core portions 3021R and 3021G are curved in such a manner that as it goes toward an emission end, a distance therebetween becomes gradually narrow, and are joined to each other at one core portion 3021 in combination with the core portion 3021B in the joining portion 3025. According to this, a red light beam LR incident to the core portion 3021R, a green light beam LG incident to the core portion 3021G, and a blue light beam LB incident to the core portion 3021B are multiplexed at the joining portion 3025. The red light beam LR, the green light beam LG, and the blue light beam LB, which are multiplexed at the joining portion 3025, are guided to the wavelength selection unit 303. That is, the optical waveguide 302 includes a multiplexing unit that multiplexes light beams with wavelengths different from each other and guides the multiplexed light beams to the wavelength selection unit.

### Wavelength Selection Unit

The wavelength selection unit 303 is disposed at one core portion 3021 after the joining.

As illustrated in FIGS. 6 and 7, the wavelength selection unit 303 includes the first electric field application unit 303R, the second electric field application unit 303G, and the third electric field application unit 303B which are provided to be sequentially arranged from the incident end (incident surface) side of the core portion 3021 to the emission end (emission surface) side. Each of the first electric field application unit 303R, the second electric field application unit 303G, and the third electric field application unit 303B can change a refractive index of the core portion 3021 by generating an electric field with respect to the optical waveguide 302 that is constituted by the core portion 3021 and the clad portion 3022. According to this, a refractive index distribution is formed between a portion to which the electric field is applied and a portion to which the electric field is not applied.

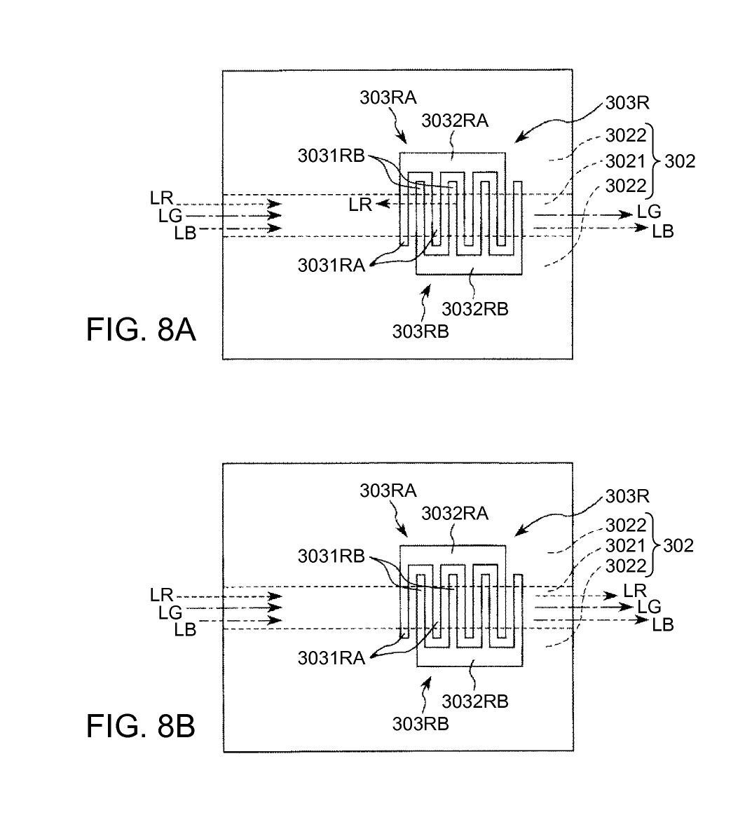

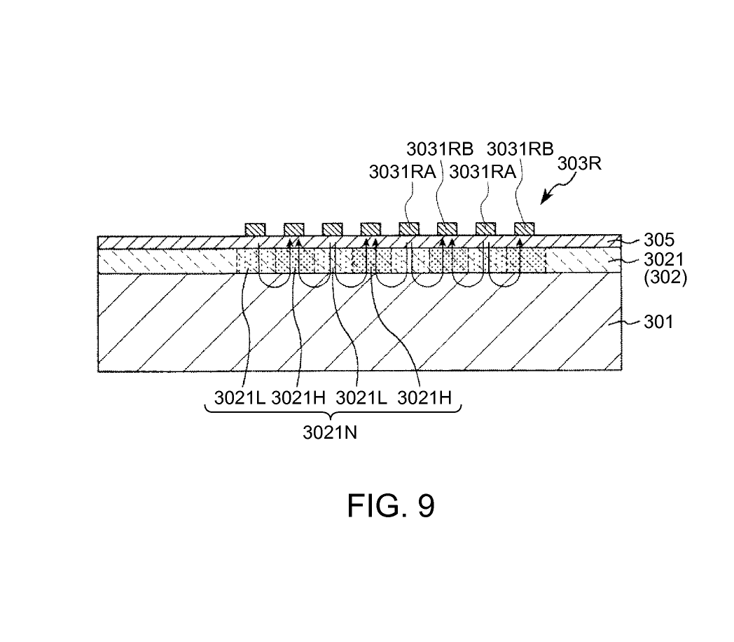

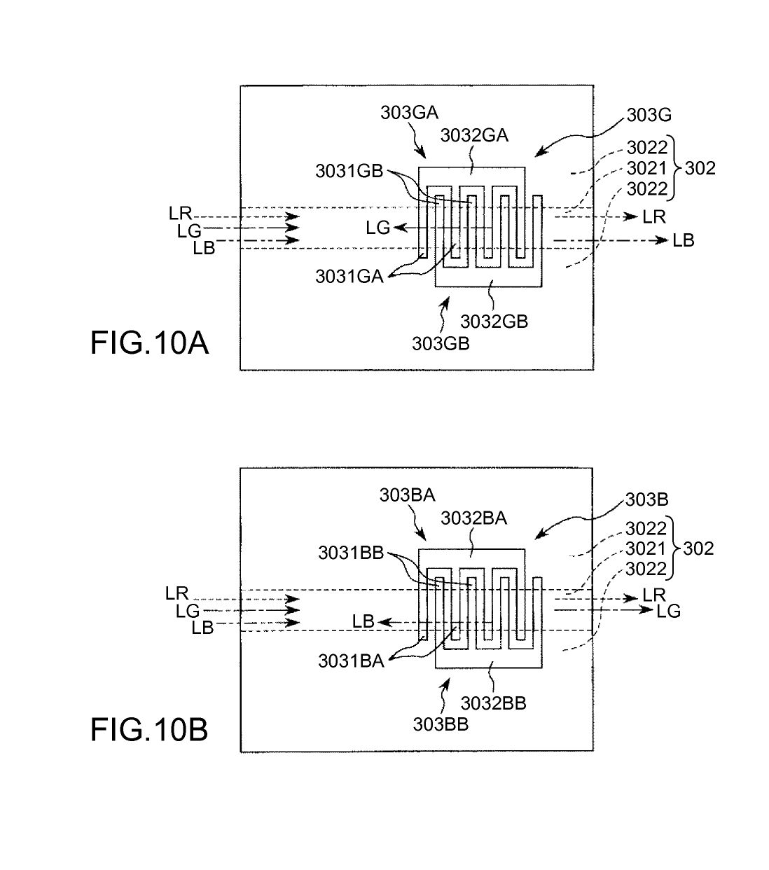

FIG. 8A is a partially enlarged view of the first electric field application unit 303R illustrated in FIG. 7, and illustrates a state in which an electric field is applied with respect to the optical waveguide 302 from the first electric field application unit 303R. FIG. 8B is a partially enlarged view of the first electric field application unit 303R illustrated in FIG. 7, and illustrates a state in which an electric field is not applied with respect to the optical waveguide 302 from the first electric field application unit 303R. FIG. 9 is a cross-sectional view when cutting the core portion 3021 in FIG. 8A along a longitudinal direction thereof. FIG. 10A is a partially enlarged view of the second electric field application unit 303G illustrated in FIG. 7, and illustrates a state in which an electric field is applied with respect to the optical waveguide 302 from the second electric field application unit 303G. FIG. 10B is a partially enlarged view of the third electric field application unit 303B illustrated in FIG. 7, and illustrates a state in which an electric field is applied with respect to the optical waveguide 302 from the third electric field application unit 303B.

In the wavelength selection unit 303, the first electric field application unit 303R includes a plurality of first electrodes 3031RA and a plurality of second electrodes 3031RB as illustrated in FIG. 8A. The first electrodes 3031RA and the second electrodes 3031RB have an elongated shape in a plan view, and are arranged in such a manner that a longitudinal direction of elongated portions intersects the optical wave-guiding direction (a right and left direction in FIGS. 8A and 8B) of the optical waveguide 302 and overlaps with the core portion 3021.

The plurality of first electrodes 3031RA are electrically connected to each other through a connection portion 3032RA. According to this, the plurality of first electrodes 3031RA and the connection portion 3032RA constitute a first inter-digital electrode 303RA.

On the other hand, the plurality of the second electrode 3031RB are electrically connected to each other through a connection portion 3032RB. According to this, the plurality of second electrodes 3031RB and the connection portion 3032RB constitute a second inter-digital electrode 303RB.

When a potential difference is applied between the first inter-digital electrode 303RA and the second inter-digital electrode 303RB, lines of electric force occur in a core portion 3021 (optical waveguide 302) in the vicinity of the electrodes in accordance with a potential applied to the respective electrodes. That is, an electric field is applied to the core portion 3021. FIG. 9 schematically illustrates an example of the lines of electric force with an arrow. When the lines of electric force occurred, a refractive index varies in the core portion 3021 on the basis of the electro-optical effect. At this time, the way of variation in the refractive index varies in accordance with a direction of the lines of electric force (direction of the electric field).

In the first electric field application unit 303R, the first electrodes 3031RA which belong to the first inter-digital electrode 303RA, and the second electrodes 3031RB which belong to the second inter-digital electrode 303RB are disposed to be alternately arranged along the optical wave-guiding direction. Accordingly, with regard to the direction of the lines of electric force which occur in the core portion 3021, lines of electric force in directions opposite to each other alternately occur along the optical wave-guiding direction. As a result, a portion in which the refractive index is relatively high, and a portion in which the refractive index is relatively low alternately occur in the core portion 3021. The direction of the lines of electric force and a refractive index variation direction vary in accordance with a structure of a material having the electro-optical effect. In FIG. 9, as an example, in the core portion 3021, the portion in which the refractive index is relatively high is indicated by relatively dense dots as a “high refractive index portion 3021H”, and the portion in which the refractive index is relatively low is indicated by relatively less dense dots as a “low refractive index portion 3021L”.

In this state, when the first electric field application unit 303R is driven, a first refractive index distribution 3021N, in which the high refractive index portion 3021H and the low refractive index portion 3021L are periodically provided along the optical wave-guiding direction, is formed.

As described above, when using the first inter-digital electrode 303RA and the second inter-digital electrode 303RB in combination with each other, it is possible to realize simplification of an electrode structure and a reduction in a wiring length for connection between an electrode and an external power supply.

On the other hand, in a case where a potential difference is not applied between the first inter-digital electrode 303RA and the second inter-digital electrode 303RB, an electric field is not applied to the core portion 3021 (optical waveguide 302) in the vicinity of the electrode, and thus the refractive index does not vary, and the first refractive index distribution 3021N is not formed. According to this, as illustrated in FIG. 8B, the red light beam LR, the green light beam LG, and the blue light beam LB are transmitted through the first electric field application unit 303R without being reflected.

However, as is the case with the first refractive index distribution 3021N, a refractive index variation (grating), which periodically occurs, is provided partway the core portion 3021, it is possible to reflect only a light beam with a specific wavelength corresponding to a refractive index variation period among light beams which propagate through the core portion 3021. Accordingly, when appropriately selecting the refractive index variation period, it is possible to reflect only light beams of several colors among multiplexed light beams of the red light beam LR, the green light beam LG, and the blue light beam LB, which are multiplexed in the above-described multiplexing unit, without transmission.

The reflection is based on so-called Bragg reflection. In the Bragg reflection, a wavelength that is reflected is determined on the basis of an effective refractive index (for example, an average of refractive indexes before and after variation) in a refractive index variation, and the refractive index variation period (first period). In the effective refractive index and the wavelength, the effective refractive index can be determined on the basis of a material having the electro-optical effect, and intensity of an electric field that is applied to the optical waveguide 302. On the other hand, the refractive index variation period can be determined on the basis of an arrangement period of the plurality of first electrodes 3031RA and the plurality of second electrodes 3031RB.

Accordingly, in the first electric field application unit 303R, in order for only the red light beam LR to be reflected through the Bragg reflection, a material having the electro-optical effect may be selected, the intensity of the electric field that is applied to the optical waveguide 302 may be adjusted, or the arrangement period of the plurality of first electrodes 3031RA and the plurality of second electrodes 3031RB may be adjusted. Accordingly, in other words, the first electric field application unit 303R can be referred to as a reflection unit (first reflection unit) capable of reflecting the red light beam LR (a light beam with a first wavelength) by using the Bragg reflection.

A reflection direction depends on the refractive index variation direction in the first refractive index distribution 3021N, and depends on an intersection angle between the longitudinal direction of the first electrodes 3031RA and the second electrodes 3031RB, and the optical wave-guiding direction of the optical waveguide 302. Accordingly, when appropriately setting the shape (orientation in the longitudinal direction) of the first electrodes 3031RA and the second electrode 3031RB and an orientation in the longitudinal direction so as to adjust a reflection direction of the red light beam LR, it is possible to prevent a reflected light beam from being returned to the light source 311R side, or it is possible to prevent the reflected light beam from being a stray light beam.

In the wavelength selection unit 303, the second electric field application unit 303G includes a plurality of first electrodes 3031GA and a plurality of second electrodes 3031GB as illustrated in FIG. 10A. The first electrodes 3031GA and the second electrodes 3031GB are configured in the same manner as the first electrodes 3031RA and the second electrodes 3031RB.

The plurality of first electrodes 3031GA are electrically connected to each other through a connection portion 3032GA. According to this, the plurality of first electrodes 3031GA and the connection portion 3032GA constitute a first inter-digital electrode 303GA.

On the other hand, the plurality of the second electrode 3031GB are electrically connected to each other through a connection portion 3032GB. According to this, the plurality of second electrodes 3031GB and the connection portion 3032GB constitute a second inter-digital electrode 303GB.

When a potential difference is allowed to occur between the first inter-digital electrode 303GA and the second inter-digital electrode 303GB, as is the case with the first electric field application unit 303R, a second refractive index distribution, in which the refractive index varies in a second period along the optical wave-guiding direction, is formed.

In the second electric field application unit 303G, in order for only the green light beam LG to be reflected through the Bragg reflection, a material having the electro-optical effect may be selected, the intensity of the electric field that is applied to the optical waveguide 302 may be adjusted, or the arrangement period of the plurality of first electrodes 3031GA and the plurality of second electrodes 3031GB may be adjusted. Accordingly, in other words, the second electric field application unit 303G can be referred to as a reflection unit (second reflection unit) capable of reflecting the green light beam LG (a light beam with a second wavelength) by using the Bragg reflection.

In the wavelength selection unit 303, the third electric field application unit 303B includes a plurality of first electrode 3031BA and a plurality of second electrodes 3031BB as illustrated in FIG. 10B. The first electrodes 3031BA and the second electrodes 3031BB are configured in the same manner as the first electrodes 3031RA and the second electrodes 3031RB.

The plurality of first electrodes 3031BA are electrically connected to each other through a connection portion 3032BA. According to this, the plurality of first electrodes 3031BA and the connection portion 3032BA constitute a first inter-digital electrode 303BA.

On the other hand, the plurality of the second electrode 3031BB are electrically connected to each other through a connection portion 3032BB. According to this, the plurality of second electrodes 3031BB and the connection portion 3032BB constitute a second inter-digital electrode 303BB.

When a potential difference is allowed to occur between the first inter-digital electrode 303BA and the second inter-digital electrode 303BB, as is the case with the first electric field application unit 303R and the second electric field application unit 303G, a third refractive index distribution, in which the refractive index varies in a third period along the optical wave-guiding direction, is formed.

In the third electric field application unit 303B, in order for only the blue light beam LB to be reflected through the Bragg reflection, a material having the electro-optical effect may be selected, the intensity of the electric field that is applied to the optical waveguide 302 may be adjusted, or the arrangement period of the plurality of first electrodes 3031BA and the plurality of second electrodes 3031BB may be adjusted. Accordingly, in other words, the third electric field application unit 303B can be referred to as a reflection unit (third reflection unit) capable of reflecting the blue light beam LB (a light beam with a third wavelength) by using the Bragg reflection.

As described above, the wavelength selection unit 303 according to this embodiment includes the first electric field application unit 303R that controls transmission of the red light beam LR by selecting whether or not the red light beam LR is to be reflected, the second electric field application unit 303G that controls transmission of the green light beam LG by selecting whether or not the green light beam LG is to be reflected, and the third electric field application unit 303B that controls transmission of the blue light beam LB by selecting whether or not the blue light beam LB is to be reflected. Accordingly, it is possible to selectively allow only a light beam of a specific wavelength (color) among multiplexed light beams to be transmitted through the wavelength selection unit 303. According to this, in the optical modulation unit 304 that is disposed on an emission side of the wavelength selection unit 303, it is possible to modulate intensity of a light beam with a specific wavelength (color). As a result, it is possible to individually modulate the intensity of the red light beam LR, the green light beam LG, and the blue light beam LB with accuracy by using one piece of the optical modulation unit 304, and thus it is possible to display a high-quality image constituted by multiple colors such as a full color while realizing a reduction in size of the optical modulator 30 or the image display apparatus 1 including the optical modulator 30.

In order words, the wavelength selection unit 303 according to this embodiment is constituted by the first electric field application unit 303R, the second electric field application unit 303G, and the third electric field application unit 303B which are arranged along the optical wave-guiding direction of the optical waveguide 302. The electric field application units include an electrode which provides an electric potential so as to apply an electric field to the optical waveguide 302, and thus the optical waveguide 302 may be arranged without division. According to this, it is not necessary to provide an optical connection site at the inside (for example, between the first electric field application unit 303R and the second electric field application unit 303G) of the wavelength selection unit 303, or between the wavelength selection unit 303 and the optical modulation unit 304. As a result, there is no demand for alignment, in which consideration into an optical path length is strictly taken, which is demanded in the related art, and thus an optical loss in accordance with optical connection is less likely to occur. Accordingly, a deficiency in an amount of a light beam is less likely to be caused, and thus it is possible to solve the problem in which an increase in power consumption is caused due to an increase in an output power of a light source for compensation of the deficiency in the amount of a light beam of a display image.

In addition, the first inter-digital electrode and the second inter-digital electrode, which are provided to each of the first electric field application unit 303R, the second electric field application unit 303G, and the third electric field application unit 303B, are formed, for example, by forming a film of a conductive material, and by patterning the film into a target shape by using a photolithography technology or an etching technology. Accordingly, it is possible to collectively form each of the inter-digital electrodes, or the following electrode of the optical modulation unit 304, and thus there is an advantage in that manufacturability is high and a reduction in the cost is possible.

Here, as described above, respective materials may be selected, or the intensity of the electric field or the electrode arrangement period may be adjusted so that only the red light beam LR is reflected in the first electric field application unit 303R, only the green light beam LG is reflected in the second electric field application unit 303G, and only the blue light beam LB is reflected in the third electric field application unit 303B. It can be said that the electrode arrangement period is an easily set parameter when considering that the electrode arrangement period can be simply and accurately set during a manufacturing process, and selectivity of a wavelength of a light beam that is reflected is high.

Accordingly, when the period of the first refractive index distribution, which reflects only the red light beam LR, is set as a “first period”, the period of the second refractive index distribution, which reflects only the green light beam LG, is set as a “second period”, and the period of the third refractive index distribution, which reflects only the blue light beam LB, is set as a “third period”, a distance between the first electrodes 3031RA and the second electrodes 3031RB, a distance between the first electrodes 3031GA and the second electrodes 3031GB, and a distance between the first electrodes 3031BA and the second electrodes 3031BB may be set in such a manner that the first period, the second period, and the third period are different from each other.

In the invention, it is not necessary for the wavelength selection unit 303 to be provided with an electrode as long as a necessary refractive index distribution can be formed by applying an electric field to the core portion 3021 in the wavelength selection unit 303. However, it is preferable that the wavelength selection unit 303 has a configuration, in which an electrode is provided to apply an electric field, in consideration of simplification of a structure or a reduction in the cost.

Next, description will be given of a method of driving the wavelength selection unit 303.

In the signal generation unit 3 including the optical modulator 30 according to the invention, a transmission wavelength is selected in the wavelength selection unit 303 of the optical modulator 30, and the intensity modulation is conducted in the optical modulation unit 304 while continuously driving (CW driving) the light sources 311R, 311G, and 311B.

The wavelength selection unit 303 selects whether or not to transmit the red light beam LR in the first electric field application unit 303R, selects whether or not to transmit the green light beam LG in the second electric field application unit 303G, and selects whether or not to transmit the blue light beam LB in the third electric field application unit 303B. At this time, for example, it is preferable that a period of time in which the red light beam LR is transmitted through the wavelength selection unit 303, a period of time in which the green light beam LG is transmitted through the wavelength selection unit 303, and a period of time in which the blue light beam LB is transmitted through the wavelength selection unit 303 do not overlap with each other. If the period of time in which the red light beam LR is transmitted and the period of time in which the green light beam LG is transmitted overlap with each other, light beams in which a red color and a green color are mixed-in are incident to the optical modulation unit 304, and thus there is a concern that it is difficult to accurately conduct the intensity modulation in the optical modulation unit 304. As a result, there is a concern that an unintended variation occurs in a color of an image that is displayed by the image display apparatus 1, and an image quality may deteriorate.

Accordingly, in a case of changing a light beam, which is to be transmitted, in the wavelength selection unit 303, it is preferable to provide a period of time in which all light beams are not temporarily transmitted. When providing this period of time, all of the red light beam LR, the green light beam LG, and the blue light beam LB are reflected, and are not transmitted through the wavelength selection unit 303. Accordingly, for example, the period of time in which the red light beam LR is transmitted and the period of time in which the green light beam LG is transmitted are prevented from overlapping with each other. As a result, it is possible to prevent the image quality of the image displayed by the image display apparatus 1 from deteriorating.

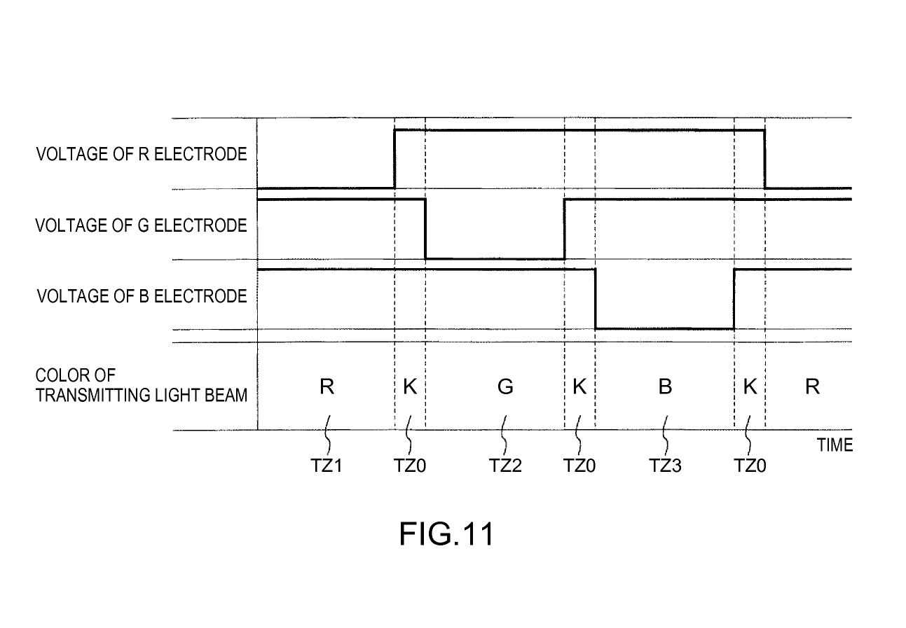

FIG. 11 is a view illustrating an example of a time transition (timing chart) of a voltage application pattern for driving the first electric field application unit 303R, the second electric field application unit 303G, and the third electric field application unit 303B, and a color of a light beam that is transmitted through the wavelength selection unit 303 at that time. In FIG. 11, a voltage, which is applied between the first inter-digital electrode 303RA and the second inter-digital electrode 303RB which are provided to the first electric field application unit 303R, is described as a “voltage of an R electrode”. Similarly, a voltage, which is applied between the first inter-digital electrode 303GA and the second inter-digital electrode 303GB which are provided to the second electric field application unit 303G, is described as a “voltage of an G electrode”, and a voltage, which is applied between the first inter-digital electrode 303BA and the second inter-digital electrode 303BB which are provided to the third electric field application unit 303B, is described as a “voltage of an B electrode”. In addition, in FIG. 11, in a case where a color of a light beam that is transmitted through the wavelength selection unit 303 is red, the color is described as “R”. Further, in a case where the color is green, the color is described as “G”, and in a case where the color is blue, the color is described as “B”. Further, in a case where no light beam is transmitted, this case is described as “K”.

For example, in the first period of time TZ1, a voltage is applied to the G electrode and the B electrode, respectively, and a voltage is not applied to the R electrode. At this time, the red light beam LR is transmitted through the first electric field application unit 303R. On the other hand, the green light beam LG is reflected in the second electric field application unit 303G, and the blue light beam LB is reflected in the third electric field application unit 303B. According to this, only the red light beam LR propagates to the optical modulation unit 304, and thus it is possible to modulate the intensity of the red light beam LR.

Next, in the second period of time TZ2, a voltage is applied to the R electrode and the B electrode, respectively, and a voltage is not applied to the G electrode. According to this, only the green light beam LG propagates to the optical modulation unit 304, and thus it is possible to modulate the intensity of the green light beam LG.

Here, during transition from the first period of time TZ1 to the second period of time TZ2, it is preferable to provide a period of time TZ0, in which a voltage is applied to all of the R electrode, the G electrode, and the B electrode, between the first period of time TZ1 and the second period of time TZ2. When the period of time TZ0 is provided, all light beams are reflected in the wavelength selection unit 303, and thus a transmitting light beam does not exist. In addition, the first period of time TZ1 and the second period of time TZ2 are prevented from overlapping with each other, and thus it is possible to prevent light beams, in which the red light beam LR and the green light beam LG are mixed in, from propagating to the optical modulation unit 304.

The length of the period of time TZ0 is appropriately set in accordance with factors such as time necessary to apply a predetermined voltage to the respective electrodes, a variation in the time, and time necessary to stop the application of a voltage to the respective electrodes or a variation in the time, and as an example, the length is set to approximately 1 nanosecond to 100 milliseconds. Although also different depending on the contents of an image that is displayed or an individual difference, at the above-described length, a user is less likely to be conscious of a state in which no light beam is not transmitted (a black display state) and to have uncomfortable feeling, and thus it is possible to minimize a decrease in image quality due to the black display. In addition, it is also possible to minimize a decrease in image quality due to overlapping of the first period of time TZ1 and the second period of time TZ2.

Similarly, during transition from the second period of time TZ2 to the third period of time TZ3, it is preferable to provide the period of time TZ0, in which a voltage is applied to all of the R electrode, the G electrode, and the B electrode, between the second period of time TZ2 and the third period of time TZ3. According to this, the second period of time TZ2 and the third period of time TZ3 are prevented from overlapping with each other, and thus it is possible to prevent light beams, in which the green light beam LG and the blue light beam LB are mixed in, from propagating to the optical modulation unit 304.

The shape of the respective inter-digital electrodes is not limited to a shape that is illustrated, and is appropriately set in accordance with, for example, a direction of a crystal axis of the material which constitutes the substrate 301 and has the electro-optical effect.

The first inter-digital electrode 303RA and the second inter-digital electrode 303RB which are illustrated in FIGS. 8A and 8B use a substrate (a Z-axis cut crystal substrate), which has a cut-surface perpendicular to the Z-axis of a crystal, as a material that constitutes the substrate 301. Accordingly, the first inter-digital electrode 303RA and the second inter-digital electrode 303RB have a shape and arrangement in which an electric field is effectively applied along the Z-axis.

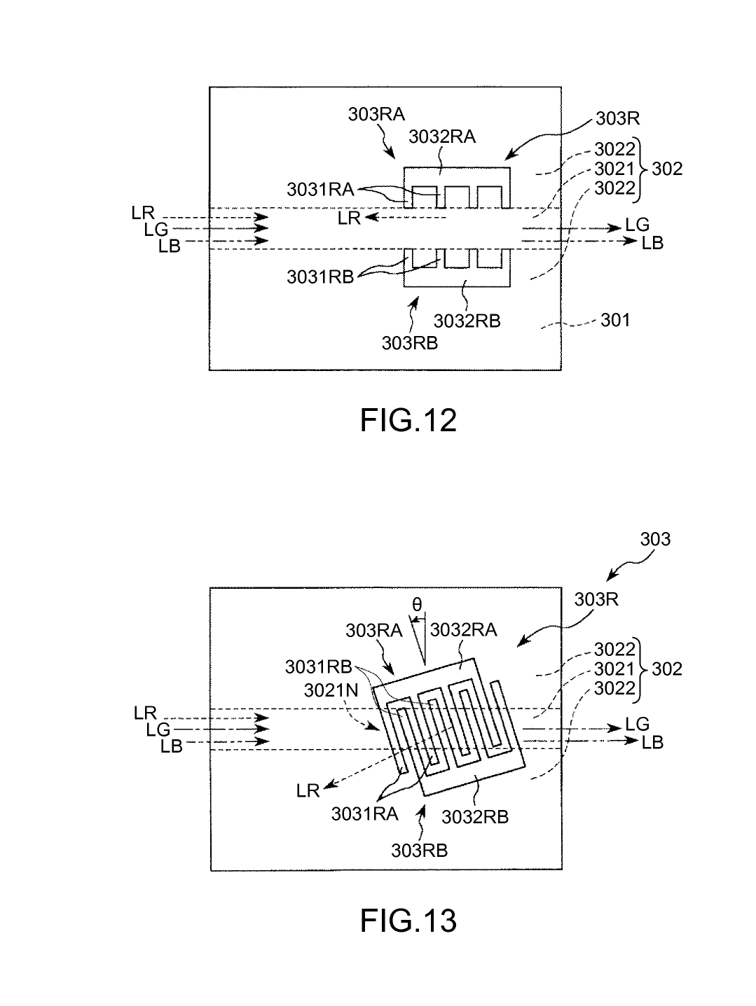

FIG. 12 is a view illustrating another configuration example of the respective inter-digital electrodes. In FIG. 12, the same reference numeral is given to the same components as in FIGS. 8A and 8B.

The first inter-digital electrode 303RA and the second inter-digital electrode 303RB which are illustrated in FIG. 12 uses a substrate (X-cut crystal substrate), which has a cut-surface perpendicular to the X-axis of a crystal, as a material that constitutes the substrate 301. Accordingly, first inter-digital electrode 303RA and the second inter-digital electrode 303RB have a shape and arrangement which are different from those in the respective inter-digital electrodes illustrated in FIGS. 8A and 8B.

Specifically, in the first inter-digital electrode 303RA and the second inter-digital electrode 303RB which are illustrated in FIG. 12, the first electrodes 3031RA and the second electrodes 3031RB are arranged not to overlap with the core portion 3021 of the optical waveguide 302 in a plan view of the substrate 301. The first electrodes 3031RA and the second electrodes 3031RB are configured to be located at the same position in the optical wave-guiding direction of the optical waveguide 302. In other words, the first electrodes 3031RA and the second electrodes 3031RB are provided in a pair with the core portion 3021 of the optical waveguide 302 interposed therebetween. According to this, lines of electric force are likely to concentrate between the first inter-digital electrode 303RA and the second inter-digital electrode 303RB, and thus it is easy to apply an electric field in this direction.

As is the case with the respective inter-digital electrodes illustrated in FIGS. 8A and 8B, it is possible to effectively form the first refractive index distribution 3021N with the first inter-digital electrode 303RA and the second inter-digital electrode 303RB which are illustrated in FIG. 12.

### Optical Modulation Unit

The optical modulation unit 304 is disposed on an emission surface side of the wavelength selection unit 303. The optical modulation unit 304 may be an arbitrary unit as long as the optical modulation unit 304 is capable of modulating the intensity of a light beam that propagates through the optical waveguide 302. However, in this embodiment, description will be particularly given of an optical modulation unit that employs a March-Zehnder type optical modulation type.

At a portion corresponding to the optical modulation unit 304 according to this embodiment, as illustrated in FIGS. 6 and 7, the core portion 3021 is diverged into two portions including a core portion 3021a and a core portion 3021b at the diverging portion 3023. The optical modulation unit 304 includes an electrode 3040 that is provided to the diverged core portions.

The core portion 3021a and the core portion 3021b are spaced away from each other with a predetermined distance. The core portion 3021a and the core portion 3021b are joined again into one core portion 3021 at the joining portion 3024. The core portion 3021 after joining is configured to emit an emission light beam L from an emission end (emission surface).

The electrode 3040 is constituted by a signal electrode 304a and a ground electrode 304b.

In the electrodes 304a and 304b, the signal electrode 304a is disposed to overlap with the core portion 3021a in a plan view of the substrate 301. On the other hand, the ground electrode 304b is disposed to overlap with the core portion 3021b in a plan view of the substrate 301.

A reference potential is applied to the ground electrode 304b. As an example, the ground electrode 304b is electrically grounded. On the other hand, a potential based on image information is applied to the signal electrode 304a so that a potential difference occurs between the signal electrode 304a and the ground electrode 304b. In this state, when the potential difference occurs between the signal electrode 304a and the ground electrode 304b, an electric field is applied to the core portion 3021a through which lines of electric force occurred between the signal electrode 304a and the ground electrode 304b. As a result, a refractive index of the core portion 3021a varies on the basis of the electro-optical effect.

Here, the signal electrode 304a has a width narrower than that of the ground electrode 304b. According to this, the lines of electric force concentrate to the core portion 3021a that is located immediately below the signal electrode 304a. That is, a relatively strong electric field is applied to the core portion 3021a from the signal electrode 304a. On the other hand, the width of the ground electrode 304b is set to be sufficiently broad. According to this, the lines of electric force does not concentrate so much to the core portion 3021b that is located immediately below the ground electrode 304b. That is, a relatively weak electric field is applied to the core portion 3021b from the ground electrode 304b.

The core portion 3021a and the core portion 3021b are different from each other as described above, and thus when the above-described potential difference occurs with respect to the electrode 3040, the refractive index of the core portion 3021a that is located in correspondence with the signal electrode 304a mainly varies, and the refractive index of the core portion 3021b hardly varies. As a result, a deviation in the refractive index occurs between the core portion 3021a and the core portion 3021b, and thus a phase difference based on the deviation in the refractive index occurs between a light beam propagating through the core portion 3021a and a light beam propagating through the core portion 3021b. When the two light beams, between which the phase difference occurs as described above, are multiplexed at the joining portion 3024, a multiplexed light beam that is attenuated from incident intensity is generated. The multiplexed light beam is emitted from the emission end of the core portion 3021 toward the optical detection unit 34.

At this time, when a potential difference that is applied between the signal electrode 304a and the ground electrode 304b is adjusted, it is possible to control a phase difference between a light beam that propagates through the core portion 3021a and a light beam that propagates through the core portion 3021b, and thus it is possible to control an attenuation width from the incident intensity in the multiplexed light beam.

For example, when the potential difference that occurs between the signal electrode 304a and the ground electrode 304b is adjusted, thereby making the phase difference between the light beam propagating through the core portion 3021a and the light beam propagating through the core portion 3021b deviate by a half-wavelength at the joining portion 3024, the two light beams collide with each other at the joining portion 3024 and disappear. Accordingly, optical intensity becomes substantially zero. In addition, an amount of deviation in the phase is made to appropriately vary, it is possible to modulate the optical intensity of a multiplexed light beam.

On the other hand, when the phases of the two light beams are aligned at the joining portion 3024, a multiplexed light beam with optical intensity, which is approximately the same as the incident intensity, is obtained.

In this embodiment, the red light beam LR, the green light beam LG, and the blue light beam LB are incident to the optical modulation unit 304 in a time-division manner. Accordingly, in the period of time in which the red light beam LR is incident, the optical modulation unit 304 is driven so as to modulate the intensity of the red light beam LR on the basis of image information. Similarly, in the period of time in which the green light beam LG is incident, the optical modulation unit 304 is driven so as to modulate the intensity of the green light beam LG on the basis of the image information, and in the period of time in which the blue light beam LB is incident, the optical modulation unit 304 is driven so as to modulate the intensity of the blue light beam LB on the basis of the image information. According to this, in one optical modulation unit 304, it is possible to conduct intensity modulation of the light beams of three colors including the red light beam LR, the green light beam LG, and the blue light beam LB. As a result, it is possible to realize a reduction in size and simplification of a structure in the optical modulator 30.

According to the image display apparatus 1, it is possible to conduct external modulation of the intensity of the three colors of light beams in the optical modulation unit 304. According to this, it is possible to realize high-speed modulation in comparison to a case where the intensity of the three colors of light beams emitted from the light source unit 311 is directly modulated in the light source unit 311. In addition, a voltage that is applied to the electrode 3040 is finely changed, it is possible to conduct minute adjustment of the intensity of a light beam, which is emitted from the optical modulator 30, with high resolution. As a result, it is possible to further increase a gradation of an image that is drawn on the retina of the eye EY, and thus it is possible to further realize high definition.

In addition, in the image display apparatus 1, it is not necessary to directly modulate the light source unit 311, and thus the light source unit 311 may be driven in order for a signal light beam with constant intensity to be emitted. Accordingly, it is possible to drive the light source unit 311 under conditions in which light-emitting efficiency is the highest, or under conditions in which light-emitting stability or wavelength stability is the highest. As a result, it is possible to realize low power consumption of the image display apparatus 1, or operation stability thereof. Further, it is possible to realize a high quality of an image that is drawn on the retina of the eye EY. In addition, a drive circuit necessary for direction modulation of the light source unit 311 is not necessary, and a circuit configured to continuously drive the light source unit 311 is simple and inexpensive, and thus it is possible to realize a reduction in the cost for the light source unit 311 and a reduction in size of the light source unit 311.

In a case of using the following holographic diffraction grating as the reflection unit 6, it is possible to increase the wavelength stability of the signal light beam, and thus it is possible to allow a signal light beam close to a designed wavelength to be incident to the holographic diffraction grating. As a result, it is possible to make a deviation from a designed value of a diffraction angle small in the holographic diffraction grating, and thus it is possible to suppress haziness of an image.

As is the case with the first inter-digital electrode and the second inter-digital electrode which are provided to the first electric field application unit 303R, the second electric field application unit 303G, and the third electric field application unit 303B of the above-described wavelength selection unit 303, the electrode 3040 can be formed by forming a film of a conductive material, and by patterning the film into a target shape by using a photolithography technology or an etching technology.

Accordingly, the electrode 3040 can be collectively formed when forming the respective inter-digital electrodes of the wavelength selection unit 303. As a result, it is possible to efficiently manufacture the optical modulation unit 304, and thus it is possible to realize a reduction in the cost. In addition, it is possible to easily control positional accuracy between the respective inter-digital electrodes of the wavelength selection unit 303, and the electrode 3040 of the optical modulation unit 304 in a strict manner, and thus it is possible to realize high positional accuracy. As a result, selection of a color of a light beam and intensity modulation of the light beam can be conducted with high accuracy, and thus it is possible to realize an additional high quality of the image that is displayed.

In addition, in this embodiment, the portion (multiplexing unit) in which the three core portions 3021R, 3021G, and 3021B are joined at the joining portion 3025, the wavelength selection unit 303, and the optical modulation unit 304 are disposed on the same substrate 301 (monolithic structure). According to this, a reduction in size of the optical modulator 30 is realized and a reduction in size of the image display apparatus 1 is realized in comparison to a case where these units are configured as an individual member. In addition, it is possible to realize a reduction in optical coupling loss between respective units, and thus it is possible to suppress an internal loss of the optical modulator 30. According to this, it is possible to realize a high quality of an image and a reduction in power consumption.

The optical modulator 30 including the optical waveguide 302 exhibits an additional effect of enhancing a beam quality of the emission light beam L and of reducing an excessive light beam. According to this, it is possible to further realize the high quality of an image that is displayed.

In the additional effects, the former effect is obtained through trimming (cut-out of an unnecessary portion) of a light beam. That is, in a light beam that is emitted from the light source unit 311, a quality of the central portion on a transverse cross-sectional surface is typically high (a wavelength distribution width is narrow), and a quality in the peripheral portion is low. Accordingly, when the optical waveguide 302 is provided to the optical modulator 30, it is possible to trim the peripheral portion of a beam at the optical waveguide 302. As a result, it is possible to emit the beam after modulating only the central portion of the beam with a high quality.

On the other hand, in the additional effects, the later effect is obtained in accordance with an easy reduction in an amount of a light beam by using a phenomenon in which a part of light beams is leaked by appropriately setting the shape of the core portion 3021 when the light beam propagates through the optical waveguide 302.

For example, the shape of the electrode 3040 is appropriately set in accordance with a direction of a crystal axis of the substrate 301, and for example, the shape may be a shape that is disposed in correspondence with a position not overlapping with the core portion 3021a or the core portion 3021b.

In addition, since a voltage is applied to a region with a narrow cross-section similar to the optical waveguide 302, it is possible to make an application voltage, which is necessary for a variation in the refractive index in order for a phase difference necessary for modulation of a signal light beam to occur, smaller in comparison to a case where a voltage is applied to a bulk electro-optical material. In addition, when a cross-sectional area of the optical waveguide 302 (core portion 3021) is appropriately selected, it is possible to enhance controllability of intensity modulation.

In addition, the above-described optical modulation unit 304 conduct external modulation of the intensity of the signal light beam by using the electro-optical effect, but it is possible to use an optical modulation effect such as an acousto-optical effect, a magneto-optical effect, a thermo-optical effect, and a non-linear optical effect instead of the electro-optical effect.

In a case of employing the March-Zehnder type optical modulation type using the electro-optical effect, particularly, modulation can be conducted at a high speed, and thus there is a great contribution to a high quality of an image that is displayed.

In addition, a modulation principle in the optical modulation unit 304 is not limited to the above-described Mach-Zehnder type modulation principle. Examples of a substitutable modulation structure include a directional coupling type modulator, a diverged interference type modulator, a ring interference type modulator, an internal total reflection type optical switch using a Y-cut cross waveguide, a diverged switch, a cut-out type optical modulator, a balance bridge type optical modulator, a Bragg diffraction type optical switch, an electrical absorption type (EA) modulator, and the like.

The Mach-Zehnder type modulation structure can be realized with a relatively simple structure, and a modulation width can be easily adjusted in an arbitrary manner, and thus the Mach-Zehnder type modulation structure is useful as a modulation structure in the optical modulation unit 304. When the modulation width is adjusted in an arbitrary manner, the intensity of the signal light beam can be adjusted in an arbitrary manner, and thus, for example, it is possible to realize high contrast of a display image.

In addition, the buffer layer 305 is provided between the substrate 301 and the respective electrodes. Further, for example, the buffer layer 305 is constituted by a medium such as silicon oxide and alumina in which absorption of a light beam that is guided through the optical waveguide 302 is small.

The emission light beam L, which is modulated in the optical modulator 30 in accordance with image information as described above, is incident to one end of the first optical fiber 71 as a signal light beam. The signal light beam passes through the first optical fiber 71, the connection unit 5, and the second optical fiber 72 in this order, and is transmitted to the following optical scanning unit 42 of the scanning light beam emitting unit 4.

Here, the optical detection unit 34 is provided in the vicinity of an end of the first optical fiber 71 on an incident side of the signal light beam. The optical detection unit 34 detects the signal light beam. In addition, the one end of the first optical fiber 71 and the optical detection unit 34 are fixed to the fixing unit 35.

The drive signal generation unit 32 generates a drive signal that drives the optical scanning unit 42 (optical scanner) of the scanning light beam emitting unit 4 to be described later.

The drive signal generation unit 32 includes a drive circuit 321 that generates a first drive signal that is used for scanning (horizontal scanning) in a first direction by the optical scanning unit 42, and a drive circuit 322 that generates a second drive signal that is used for scanning (vertical scanning) in a second direction perpendicular to the first direction by the optical scanning unit 42.

The drive signal generation unit 32 is electrically connected to the optical scanning unit 42 of the following scanning light beam emitting unit 4 through a signal line (not illustrated). According to this, a drive signal that is generated in the drive signal generation unit 32 is input to the optical scanning unit 42 of the following scanning light beam emitting unit 4.

The above-described drive circuits 312R, 312G, and 312B of the signal light beam generation unit 31, and the drive circuits 321 and 322 of the drive signal generation unit 32 are electrically connected to the control unit 33.

The control unit 33 has a function of controlling the operation of the drive circuits 312R, 312G, and 312B of the signal light beam generation unit 31, and the drive circuits 321 and 322 of the drive signal generation unit 32 on the basis of a video signal (image signal). That is, the control unit 33 has a function of controlling the operation of the scanning light beam emitting unit 4. According to this, the signal light beam generation unit 31 generates a signal light beam that is modulated in accordance with image information, and the drive signal generation unit 32 generates a drive signal in accordance with image information.

In addition, the control unit 33 has a function of controlling the operation of the optical modulator 30. Specifically, the control unit 33 can drive the wavelength selection unit 303 and the optical modulation unit 304, which are included in the optical modulator 30, in an individual manner or in a cooperative manner. According to this, it is possible to allow light beams with wavelengths different from each other to be transmitted through the wavelength selection unit 303 in an exclusive manner (time-division manner) on the time axis, and it is possible to modulate intensity of the transmitting light beam in the optical modulation unit 304 in accordance with a transmitting timing.

In addition, the control unit 33 is configured to control the operation of the drive circuits 312R, 312G, and 312B of the signal light beam generation unit 31 on the basis of intensity of a light beam which is detected by the optical detection unit 34.

### Scanning Light Beam Emitting Unit

As illustrated in FIGS. 1 and 2, the scanning light beam emitting unit 4 is attached to the vicinity of the bridge portion 26 (in other words, the vicinity of the center of the front portion 22) of the frame 2.

As illustrated in FIG. 4, the scanning light beam emitting unit 4 includes a housing 41 (casing), an optical scanning unit 42, a lens 43 (coupling lens), a lens 45 (condensing lens), and a support member 46.

The housing 41 is mounted to the front portion 22 through the support member 46.

In addition, an outer surface of the housing 41 is joined to a portion of the support member 46 on a side opposite to the frame 2.

The housing 41 supports the optical scanning unit 42 and accommodates the optical scanning unit 42 therein. In addition, the lens 43 and the lens 45 are mounted to the housing 41, and the lenses 43 and 45 constitute a part of (a part of a wall portion) of the housing 41.

In addition, the lens 43 (a window portion of the housing 41 through which a signal light beam is transmitted) is spaced away from the second optical fiber 72. In this embodiment, an end of the second optical fiber 72 on an emission side of a signal light beam is spaced away from the scanning light beam emitting unit 4 at a position that faces a reflection unit 10 provided to the front portion 22 of the frame 2.

The reflection unit 10 has a function of reflecting a signal light beam, which is emitted from the second optical fiber 72, toward the optical scanning unit 42. In addition, the reflection unit 10 is provided in a concave portion 27 that is opened on an inner side of the front portion 22. An opening of the concave portion 27 may be covered with a window portion formed from a transparent material. In addition, the reflection unit 10 is not particularly limited as long as the reflection unit 10 is capable of reflecting a signal light beam, and may be constituted by, for example, a mirror, a prism, and the like.

The optical scanning unit 42 is an optical scanner that conducts two-dimensional scanning with a signal light beam that is transmitted from the signal light beam generation unit 31. When scanning with the signal light beam is conducted by the optical scanning unit 42, a scanning light beam is formed. Specifically, a signal light, which is emitted from the second optical fiber 72, is incident to an optical reflection surface of the optical scanning unit 42 through the lens 43. The two-dimensional scanning with the signal light beam is conducted by driving the optical scanning unit 42 in accordance with a drive signal that is generated in the drive signal generation unit 32.

In addition, the optical scanning unit 42 includes a coil 17 and a signal overlapping unit 18 (refer to FIG. 4), and the coil 17, the signal overlapping unit 18, and the drive signal generation unit 32 constitute a drive unit that drives the optical scanning unit 42.

The lens 43 has a function of adjusting a spot diameter of a signal light beam that is emitted from the second optical fiber 72. In addition, the lens 43 also has a function of adjusting a radiation angle of the signal light beam, which is emitted from the second optical fiber 72, so as to approximately collimate the signal light beam.

A signal light beam (scanning light beam) that is used for scanning by the optical scanning unit 42 is emitted to an outer side of the housing 41 through the lens 45.

The scanning light beam emitting unit 4 may be provided with a plurality of optical scanning units for one-dimensional scanning with a signal light beam instead of the optical scanning unit 42 for two-dimensional scanning with the signal light beam.

### Reflection Unit

As illustrated in FIGS. 1 and 2, the reflection unit 6 (reflective optical unit) is mounted to the rim portion 25 that is included in the front portion 22 of the frame 2.

That is, the reflection unit 6 is disposed to be located in front of the eye EY of the user and on a side farther from the user in comparison to the optical scanning unit 42 during use. According to this, it is possible to prevent a portion, which protrudes to a front side with respect to the face of the user, from being formed in the image display apparatus 1.

As illustrated in FIG. 5, the reflection unit 6 has a function of reflecting a signal light beam transmitted from the optical scanning unit 42 toward the eye EY of the user.

In this embodiment, the reflection unit 6 is a half-mirror (semi-transparent mirror), and also has a function (light-transmitting property for a visible light beam) of transmitting an external light beam therethrough. That is, the reflection unit 6 has a function (combiner function) of reflecting a signal light beam (video light beam) that is transmitted from the optical scanning unit 42, and of transmitting an external light beam which propagates from an outer side of the reflection unit 6 toward the eye of the user during use. According to this, the user can visually recognize a virtual image (image) that is formed by the signal light beam while visually recognizing an external image.

That is, it is possible to realize a see-through type head-mounted display.

In the reflection unit 6, a surface on a user side is constituted by a concave reflective surface. According to this, a signal light beam that is reflected from the reflection unit 6 is focused to a user side. Accordingly, the user can visually recognize a virtual image that is more enlarged in comparison to an image that is formed on the concave surface of the reflection unit 6. According to this, it is possible to enhance visibility of an image on a user side.

On the other hand, in the reflection unit 6, a surface on a side farther from the user is constituted by a convex surface having the approximately the same curvature as that of the concave surface. According to this, an external light beam reaches the eye of the user without being greatly deflected at the reflection unit 6. Accordingly, the user can visually recognize an external image with less distortion.

The reflection unit 6 may include a diffraction grating. In this case, if the diffraction grating has various optical characteristics, it is possible to reduce the number of components of an optical system, or it is possible to increase the degree of freedom in design. For example, when using a holographic diffraction grating as the diffraction grating, it is possible to adjust an emission direction of a signal light beam that is reflected from the reflection unit 6, or it is possible to select a wavelength of the signal light beam that is reflected. In addition, when the diffraction grating has a lens effect, it is possible to adjust an imaging state of the entirety of scanning light beams composed of signal light beams which are reflected from the reflection unit 6, or it is possible to correct an aberration during reflection of the signal light beams from the concave surface.

In this embodiment, since the optical modulator 30 is used as an external modulator, a wavelength variation, which occurs during a flickering operation of a light source, is reduced. Accordingly, a diffraction angle variation at the diffraction grating is suppressed, and thus it is possible to provide an image with less image haziness. As the holographic diffraction grating, a stereo diffraction grating that is formed in an organic material due to optical interference, or a diffraction grating in which unevenness is formed on a surface of a resin material by a stamper can be used.

As the reflection unit 6, for example, a unit in which a transflective film constituted by a metal thin film or a dielectric multi-layer film is formed on a transparent substrate, or a polarization beam splitter may be used. In a case of using the polarization beam splitter, it is possible to employ a configuration in which a signal light beam transmitted from the optical scanning unit 42 becomes a deflected light beam, and a polarized light beam corresponding to the signal light beam transmitted from the optical scanning unit 42 is reflected.

### First Optical Fiber, Optical Detection Unit, and Fixing Unit

The fixing unit 35 has a function of fixing one end of the first optical fiber 71 at a position in which intensity of a light beam incident to the first optical fiber 71 from the light source unit 311 is greater than 0 and is equal to or less than a predetermined value.

According to this, it is possible to reduce the intensity of the light beam that is incident to the first optical fiber 71 from the light source unit 311.

The fixing unit 35 also has a function of fixing the optical detection unit 34. According to this, among light beams (signal light beams) emitted from the light source unit 311, it is possible to effectively use the remainder of light beams, which are not incident to the first optical fiber 71, for detection in the optical detection unit 34. It is possible to fix (constantly retain) a positional relationship between the one end of the first optical fiber 71 and the optical detection unit 34.

Even though an optical system configured to diverge signal light beams which are emitted from the light sources 311B, 311G, and 311R is not provided, the optical detection unit 34, which is fixed to the fixing unit 35, can detect the intensity of light beams which are emitted. It is possible to adjust the intensity of the light beams, which are emitted from the light sources 311B, 311G, and 311R, by the control unit 33 on the basis of the intensity of the light beams which are detected by the optical detection unit 34.

It is not necessary to provide the above-described fixing unit 35, and it is also possible to employ a configuration in which a light beam emitted from the light source unit 311 is coupled to the first optical fiber 71 without intentional optical attenuation. It is not necessary to provide the optical detection unit 34 at the position of the fixing unit 35, and the position of the optical detection unit 34 is not particularly limited as long as the amount of light beams of the light source unit 311 can be detected at the position.

### Second Embodiment

Next, description will be given of a second embodiment of the optical modulator according to the invention.

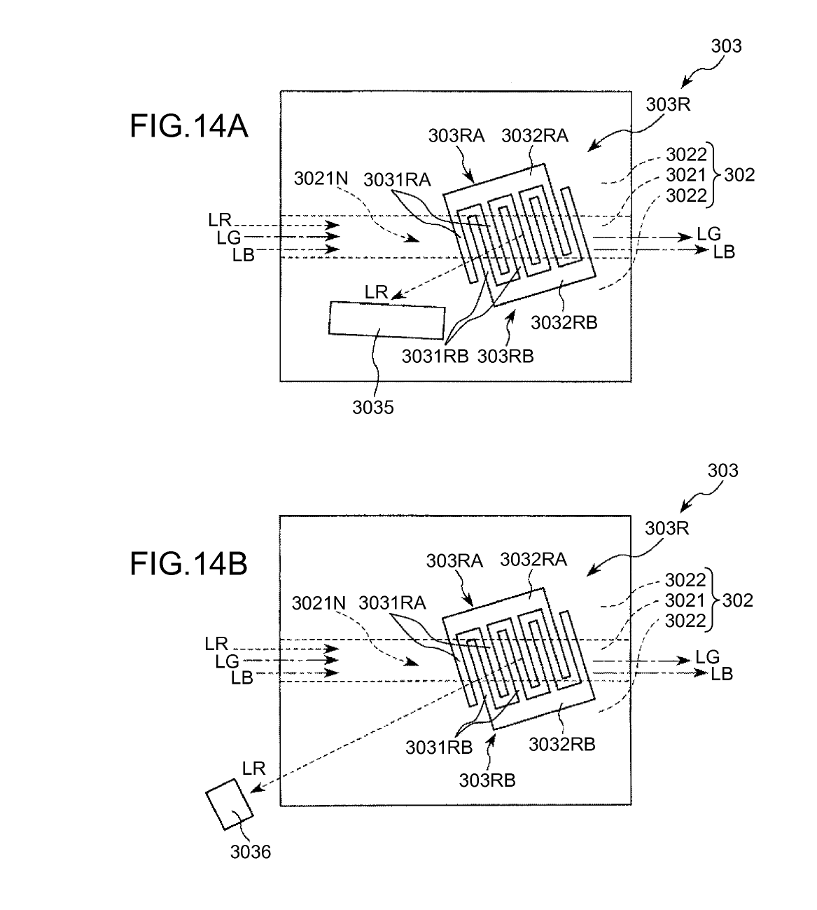

FIG. 13, and FIGS. 14A and 14B are partially enlarged plan view of a wavelength selection unit that is included in an optical modulator according to the second embodiment.

Hereinafter, the second embodiment will be described, but in the following description, description will be made with focus given to a difference from the first embodiment, and description of the same configurations will not be repeated. In the drawings, the same reference numerals will be given to the same components as in the above-described embodiment.

The first electric field application unit 303R that is included in the wavelength selection unit 303 according to the first embodiment has a configuration in which the longitudinal direction of the first electrodes 3031RA and the second electrodes 3031RB is perpendicular to the optical wave-guiding direction of the optical waveguide 302. According to this, the first electric field application unit 303R according to the first embodiment reflects the red light beam LR along the optical wave-guiding direction of the optical waveguide 302 through Bragg reflection.

In contrast, a first electric field application unit 303R that is included in a wavelength selection unit 303 according to the second embodiment has a configuration in which the longitudinal direction of first electrodes 3031RA and second electrodes 3031RB is inclined with respect to the longitudinal direction of the first electrodes 3031RA and the second electrodes 3031RB according to the first embodiment by an angle θ. According to this, a refractive index variation direction in the first refractive index distribution 3021N is also inclined with respect to the refractive index variation direction according to the first embodiment. As a result, the first electric field application unit 303R according to this embodiment reflects the red light beam LR in a direction that intersect (direction that is not perpendicular to) the optical wave-guiding direction of the optical waveguide 302.

The red light beam LR, which is reflected in this manner, propagates toward an outer side of the core portion 3021 as illustrated in FIG. 13, and is reliably separated from the red light beam LR incident to the first electric field application unit 303R. Accordingly, it is possible to prevent a situation in which the red light beam LR that is reflected reaches the light source unit 311, and thus the operation of the light source unit 311 becomes unstable, or a situation in which the red light beam LR that is reflected becomes a so-called stray light beam and is mixed in a signal light. As a result, it is possible to oscillate a red light beam LR in which a wavelength and an output are stable due to a stable operation of the light source unit 311. Further, mixing-in of the stray light beam is prevented, and thus it is possible to display an image with a high quality.

Accordingly, the inclination angle θ of the longitudinal direction of the first electrodes 3031RA and the second electrodes 3031RB is set in such a manner that the red light beam LR that is reflected by the first refractive index distribution 3021N deviates from total reflection conditions at the interface between the core portion 3021 and the clad portion 3022 and is leaked toward a clad portion 3022 side. Accordingly, the inclination angle θ is appropriately set on the basis of a difference in a refractive index between the core portion 3021 and the clad portion 3022, the wavelength of the red light beam LR that is reflected, and the like.

The first electric field application unit 303R illustrated in FIG. 14A has a configuration in which the longitudinal direction of the first electrodes 3031RA and the second electrodes 3031RB is inclined with respect to the longitudinal direction of the first electrodes 3031RA and the second electrodes 3031RB according to the first embodiment by an angle θ similar to FIG. 13. In addition to this configuration, the optical modulator 30 illustrated in FIG. 14A includes an optical absorption unit 3035 that is provided to the clad portion 3022.

The optical absorption unit 3035 has a function of absorbing the red light beam LR that is reflected by the first refractive index distribution 3021N. When the optical absorption unit 3035 is provided to the clad portion 3022, the red light beam LR that is leaked to the clad portion 3022 can be trapped into the optical absorption unit 3035. According to this, it is possible to prevent a situation in which the red light beam LR that is leaked to the clad portion 3022 again returns to the core portion 3021, or a situation in which the red light beam LR is emitted from an emission end and becomes a stray light beam.

The optical absorption unit 3035 may be disposed on an outer side of the clad portion 3022 without limitation to the clad portion 3022.

A material that constitutes the optical absorption unit 3035 is not particularly limited as long as the material can absorb a light beam, for example, a material that colors black or a dark color conforming to the black. Examples of the material include carbon black, graphite, and the like.

Although not illustrated, an additional core portion may be provided between the optical absorption unit 3035 and the core portion 3021 as necessary. According to this, the red light beam LR that is leaked from the core portion 3021 is guided to the optical absorption unit 3035 without divergence. According to this, it is possible to more reliably suppress occurrence of a stray light beam. The additional core portion may also be provided to the wavelength selection unit 303 illustrated in FIG. 13.

Similar to FIG. 13, the first electric field application unit 303R illustrated in FIG. 14B has a configuration in which the longitudinal direction of the first electrodes 3031RA and the second electrodes 3031RB is inclined with respect to the longitudinal direction of the first electrodes 3031RA and the second electrodes 3031RB according to the first embodiment by an angle θ. In addition to this configuration, the optical modulator 30 illustrated in FIG. 14B includes an optical detection unit 3036 that is provided on an outer side of the clad portion 3022.

The optical detection unit 3036 has a function of receiving the red light beam LR that is reflected by the first refractive index distribution 3021N and detects an amount of the light beam. When the optical detection unit 3036 is provided, it is possible to detect the red light beam LR that is leaked from the core portion 3021. When detecting the amount of the red light beam LR as described above, it is possible to confirm whether or not the red light beam LR is reliably reflected in the first electric field application unit 303R. In other words, it is possible to confirm that the red light beam LR is transmitted through the first electric field application unit 303R to a certain extent. In addition, when data relating to the amount of the light beam is fed back to the control unit 33, it is possible to appropriately adjust the magnitude of a voltage that is applied to the first electric field application unit 303R or an application timing of the voltage so as to reliably reflect the red light beam LR. As a result, it is possible to realize additional high quality of a display image.

As the optical detection unit 3036, for example, a photo-diode and the like are used.

In the first electric field application unit 303R illustrated in FIG. 14B, an additional core portion may also be provided between the optical detection unit 3036 and the core portion 3021 as necessary.

Even in the second embodiment, the same operation and effect as those in the first embodiment are obtained.

Hereinbefore, description has given of only the first electric field application unit 303R according to this embodiment, but the configuration of the first electric field application unit 303R according to this embodiment is also applicable to the second electric field application unit 303G or the third electric field application unit 303B.

### Third Embodiment

Next, description will be given of a third embodiment of the optical modulator according to the invention.

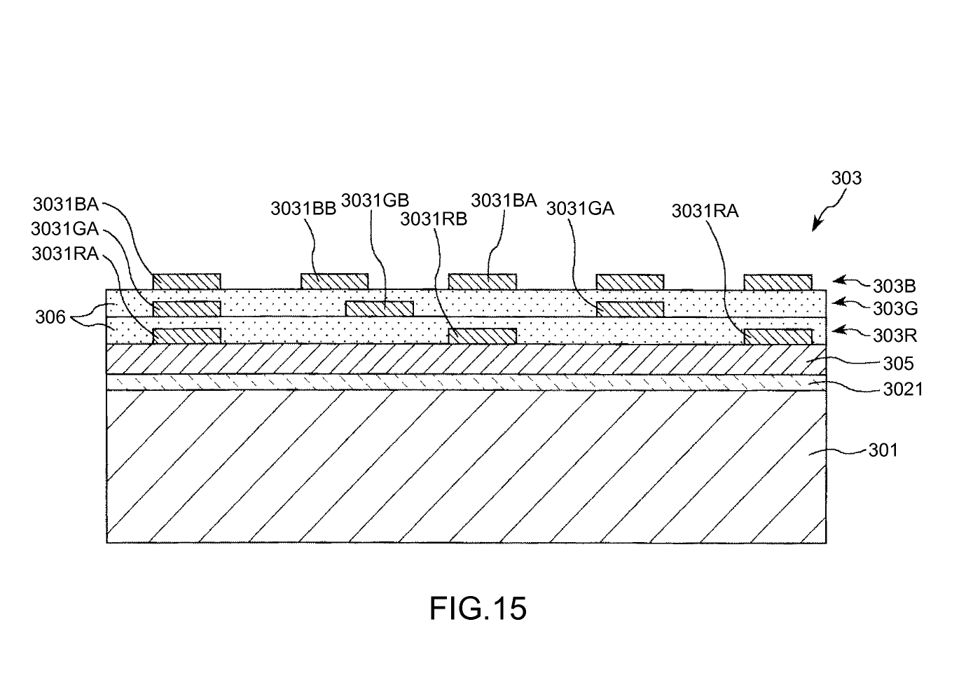

FIG. 15 is a cross-sectional view of a wavelength selection unit that is included to an optical modulator of the third embodiment.

Hereinafter, the third embodiment will be described, but in the following description, description will be made with focus given to a difference from the first and second embodiments, and description of the same configurations will not be repeated. In the drawings, the same reference numerals will be given to the same components as in the above-described embodiments.

The optical modulator 30 according to this embodiment is substantially the same as the optical modulator 30 according to the first and second embodiments except that arrangement of the first electric field application unit 303R, the second electric field application unit 303G, and the third electric field application unit 303B is different.

That is, in the wavelength selection unit 303 according to the first embodiment, the first electric field application unit 303R, the second electric field application unit 303G, and the third electric field application unit 303B are sequentially arranged in a line along the optical wave-guiding direction of the optical waveguide 302.

In contrast, in a wavelength selection unit 303 according to this embodiment, the first electric field application unit 303R, the second electric field application unit 303G, and the third electric field application unit 303B are arranged in such a manner that at least parts thereof overlap each other in a thickness direction of the substrate 301 in a plan view of the substrate 301. In this arrangement, it is possible to reduce an area which is occupied by the first electric field application unit 303R, the second electric field application unit 303G, and the third electric field application unit 303B. According to this, it is possible to realize a reduction in size of the wavelength selection unit 303, and a reduction in size of the optical modulator 30.

In the wavelength selection unit 303 illustrated in FIG. 15, a plurality of first electrodes 3031RA and a plurality of second electrodes 3031RB which are included in the first electric field application unit 303R, a plurality of first electrodes 3031GA and a plurality of second electrodes 3031GB which are included in the second electric field application unit 303G, and a plurality of first electrodes 3031BA and a plurality of second electrodes 3031BB which are included in the third electric field application unit 303B are sequentially stacked from a buffer layer 305 side. An insulating layer 306 is provided between the respective electrodes. According to this, short-circuiting between electrodes is prevented.

A material that constitutes the insulating layer 306 is not particularly limited as long as the material has insulating properties, and examples thereof include an inorganic material such as silicon oxide, silicon nitride, and glass, an organic material such as an epoxy resin and an acrylic resin, and the like.

As described above in the first embodiment, an arrangement period of the plurality of first electrodes 3031RA and the plurality of second electrodes 3031RB is set in accordance with a wavelength of the red light beam LR that is reflected in the first electric field application unit 303R. Similarly, an arrangement period of the plurality of first electrodes 3031GA and the plurality of second electrodes 3031GB is set in accordance with a wavelength of the green light beam LG that is reflected in the second electric field application unit 303G, and an arrangement period of the plurality of first electrodes 3031BA and the plurality of second electrodes 3031BB is set in accordance with a wavelength of the blue light beam LB that is reflected in the third electric field application unit 303B.

Accordingly, even in this embodiment, as illustrated in FIG. 15, an arrangement period of the plurality of first electrodes 3031RA and the plurality of second electrodes 3031RB is different from an arrangement period of the plurality of first electrodes 3031GA and the plurality of second electrodes 3031GB or an arrangement period of the plurality of first electrodes 3031BA and the plurality of second electrodes 3031BB. According to this, even though the first electric field application unit 303R, the second electric field application unit 303G, and the third electric field application unit 303B are stacked, it is possible to individually reflect the red light beam LR, the green light beam LG, and the blue light beam LB, and thus it is possible to allow only a light beam with a specific wavelength (color) to be selectively transmitted through the wavelength selection unit 303.

A ratio between the arrangement period of the plurality of first electrodes 3031RA and the plurality of second electrodes 3031RB, the arrangement period of the plurality of first electrodes 3031GA and the plurality of second electrodes 3031GB, and the arrangement period of the plurality of first electrodes 3031BA and the plurality of second electrodes 3031BB can be obtained on the basis of Bragg reflection conditions as described above, and as an example, the ratio is set to be approximately the same as a ratio between reciprocals of wavelengths of the red light beam LR, the green light beam LG, and the blue light beam LB.

Even in the third embodiment as described above, the same operation and effect as those in the first and second embodiments are obtained.

### Fourth Embodiment

Next, description will be given of a fourth embodiment of the image display apparatus according to the invention.

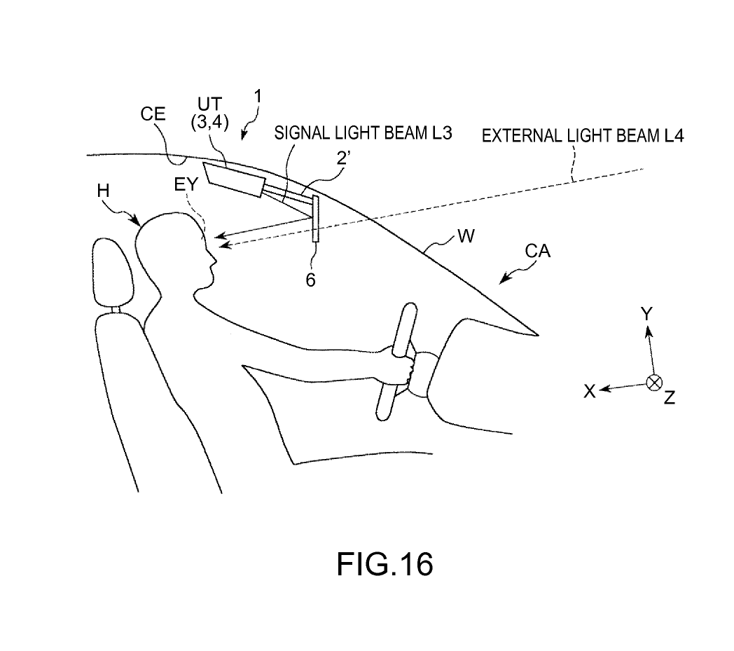

FIG. 16 is a view illustrating the fourth embodiment (head-up display) of the image display apparatus according to the invention.

Hereinafter, the fourth embodiment will be described, but in the following description, description will be made with focus given to a difference from the first embodiment, and description of the same configurations will not be repeated. In the drawings, the same reference numerals will be given to the same components as in the above-described embodiments.

The image display apparatus 1 according to the fourth embodiment is the same as the image display apparatus 1 according to the first embodiment except that the image display apparatus 1 according to this embodiment is used in a state of being mounted on the ceiling of an automobile instead of being mounted on the head of the user.

That is, the image display apparatus 1 according to the fourth embodiment is used in a state of being mounted on the ceiling CE of an automobile CA, and allows the user to visually recognize an image that is a virtual image in a state in which the image overlaps with an external image through a front window W of the automobile CA.

As illustrated in FIG. 16, the image display apparatus 1 includes a light source unit UT in which the signal generation unit 3 and the scanning light beam emitting unit 4 are embedded, a reflection unit 6, and a frame 2′ that is connected to the light source unit UT and the reflection unit 6.

In this embodiment, description is given to an example in which the light source unit UT, the frame 2′, and the reflection unit 6 are mounted to the ceiling CE of the automobile CA, but these components may be mounted on a dash board of the automobile CA, and partial components may be fixed to the front window W. In addition, the image display apparatus 1 may be mounted to not only the automobile, but also various mobile bodies such as an aircraft, a ship, construction machinery, heavy equipment, a motorcycle, a bicycle, a train, and a spacecraft.

Hereinafter, respective components of the image display apparatus 1 according to this embodiment will be sequentially described in detail.

The light source unit UT may be fixed to the ceiling CE by an arbitrary method. For example, the optical source unit UT is fixed by a method of mounting the light source unit UT to a sun visor using a band, a clip, and the like.

For example, the frame 2′ includes a pair of elongated members, and both ends of the light source unit UT and the reflection unit 6 in the Z-axis direction are connected to each other by the frame 2′, thereby fixing the light source unit UT and the reflection unit 6.

The signal generation unit 3 and the scanning light beam emitting unit 4 are embedded in the light source unit UT, and a signal light beam L3 is emitted from the scanning light beam emitting unit 4 toward the reflection unit 6.

The reflection unit 6 according to this embodiment is also a half-mirror and also has a function of transmitting an external light beam L4 therethrough. That is, the reflection unit 6 has a function of reflecting the signal light beam L3 (video light beam) emitted from the light source unit UT, and of transmitting the external light beam L4 toward the eye EY of the user from the outside of the automobile CA through the front window W during use. According to this, the user can visually recognize a virtual image (image) formed by the signal light beam L3 while visually recognizing an external image. That is, it is possible to realize a see-through type head-up display.

The above-described image display apparatus 1 also includes the signal generation unit 3 according to the first embodiment as described above. According to this, even though a plurality of light beams with wavelengths different from each other can be modulated at a high speed, the light utilization efficiency is high, and thus it is possible to realize a high quality of a display image. That is, the same operation and effect as those in the first embodiment are obtained. Further, it is easy to reduce the size, and thus there is also an advantage that the behavior of the user is less likely to be blocked.

Hereinbefore, the optical modulator and the image display apparatus according to the invention have been described on the basis of the embodiments illustrated in the drawings, but the invention is not limited to the embodiments.

For example, in the image display apparatus according to the invention, the configuration of the respective components may be substituted with an arbitrary configuration capable of exhibiting the same function, and an arbitrary configuration may be added.

In the optical modulator according to the invention, two colors of light beams may be incident thereto, or four or more colors of light beams may be incident thereto.

The reflection unit may be provided with a flat reflective surface.

The embodiments of the image display apparatus according to the invention is not limited to the above-described heat-mounted display or the head-up display, and are applicable to any type as long as the embodiment has a retina scanning type display principle.

The optical modulator according to the invention may be used for a use other than the image display apparatus. Examples of the use include a wavelength multiplex optical communication, and examples of an apparatus include a communication apparatus, a computing apparatus, and the like.

The entire disclosure of Japanese Patent Application No. 2014-202402 filed Sep. 30, 2014 is expressly incorporated by reference herein.

What is claimed is:

1. An optical modulator comprising:
an optical waveguide that is constituted by a material having an electro-optical effect;
a wavelength selector that is provided to the optical waveguide, and selects a wavelength of a light beam that is guided through the optical waveguide; and
an optical modulator that is provided to the optical waveguide, and modulates intensity of a light beam with a wavelength selected by the wavelength selector,
wherein the wavelength selector includes,
a first electric field applicator that is capable of forming a first refractive index distribution in which a refractive index periodically varies in a first period along an optical wave-guiding direction of the optical waveguide, and
a second electric field applicator that is capable of forming a second refractive index distribution in which a refractive index periodically varies in a second period different from the first period along the optical wave-guiding direction of the optical waveguide.

2. The optical modulator according to claim 1,
wherein the first electric field applicator is provided with an interval corresponding to the first period, and includes an electrode capable of applying a voltage to the optical waveguide, and
the second electric field applicator is provided with an interval corresponding to the second period, and includes an electrode capable of applying a voltage to the optical waveguide.

3. The optical modulator according to claim 2,
wherein the electrode of the first electric field applicator includes,
a first inter-digital electrode that includes a plurality of first electrodes, and a connection portion that connects the plurality of first electrodes to each other, and
a second inter-digital electrode that includes a plurality of second electrodes, and a connection portion that connects the plurality of second electrodes to each other.

4. The optical modulator according to claim 2,
wherein the electrode of the first electric field applicator has an elongated portion in a plan view, and a longitudinal direction of the elongated portion intersects the optical wave-guiding direction of the optical waveguide.

5. The optical modulator according to claim 3,
wherein the electrode of the first electric field applicator has an elongated portion in a plan view, and a longitudinal direction of the elongated portion intersects the optical wave-guiding direction of the optical waveguide.

6. The optical modulator according to claim 4,
wherein the longitudinal direction and the optical wave-guiding direction are not perpendicular to each other.

7. The optical modulator according to claim 5,
wherein the longitudinal direction and the optical wave-guiding direction are not perpendicular to each other.

8. The optical modulator according to claim 6,
wherein the first refractive index distribution is formed to reflect a light beam that is guided through the optical waveguide, and
the wavelength selector further includes an optical absorptor that absorbs a light beam that is reflected with the first refractive index distribution.

9. The optical modulator according to claim 6,
wherein the first refractive index distribution is formed to reflect a light beam that is guided through the optical waveguide, and
the wavelength selector further includes an optical detector that detects an amount of a light beam that is reflected with the first refractive index distribution.

10. The optical modulator according to claim 1,
wherein the material having the electro-optical effect is lithium niobate.

11. The optical modulator according to claim 1,
wherein the optical modulator is a Mach-Zehnder type optical modulator.

12. The optical modulator according to claim 1,
wherein the optical waveguide includes a plurality of core portions which are connected to an incident surface from which a light beam is incident to the optical waveguide, and a multiplexer that multiplexes the plurality of core portions and connects the plurality of core portions to the wavelength selector.

13. An optical modulator comprising:
an optical waveguide that is constituted by a material having an electro-optical effect;
a wavelength selector that is provided to the optical waveguide, and selects a wavelength of a light beam that is guided through the optical waveguide; and
an optical modulator that is provided to the optical waveguide, and modulates intensity of a light beam with a wavelength selected by the wavelength selector,
wherein the wavelength selector includes,
a first reflector that is capable of reflecting a light beam with a first wavelength, which is guided through the optical waveguide, by using Bragg reflection, and
a second reflector that is capable of reflecting a light beam with a second wavelength different from the first wavelength, which is guided through the optical waveguide, by using the Bragg reflection.

14. An image display apparatus comprising:
a light source that emits a light beam with a first wavelength which is reflected with a first refractive index distribution, and a light beam with a second wavelength which is reflected with a second refractive index distribution;
the optical modulator according to claim 1 to which the light beam with the first wavelength and the light beam with the second wavelength are incident; and
an optical scanner that performs spatial scanning with a light beam modulated by the optical modulator.

15. The image display apparatus according to claim 14,
wherein in a first period of time, the wavelength selector is driven in order for the second refractive index distribution to be formed, and the optical modulator is driven to modulate intensity of a light beam with the first wavelength which is transmitted through the wavelength selector, and
in a second period of time different from the first period of time, the wavelength selector is driven in order for the first refractive index distribution to be formed, and the optical modulator is driven to modulate intensity of a light beam with the second wavelength which is transmitted through the wavelength selector.

16. The image display apparatus according to claim 15,
wherein during transition from the first period of time to the second period of time, in a period of time between the first period of time and the second period of time, the wavelength selector is driven to reflect both the light beam with the first wavelength and the light beam with the second wavelength.

17. An image display apparatus, comprising:
a light source that emits a light beam with a first wavelength, and a light beam with a second wavelength;
the optical modulator according to claim 13 to which the light beam with the first wavelength and the light beam with the second wavelength are incident; and
an optical scanner for spatial scanning with a light beam that is modulated by the optical modulator.

18. The image display apparatus according to claim 14, further comprising:
a reflective optical unit that reflects a light beam used for scanning by the optical scanner,
wherein the reflective optical unit includes a holographic diffraction grating.

19. The image display apparatus according to claim 15, further comprising:
a reflective optical unit that reflects a light beam used for scanning by the optical scanner,
wherein the reflective optical unit includes a holographic diffraction grating.

20. The image display apparatus according to claim 16, further comprising:
a reflective optical unit that reflects a light beam used for scanning by the optical scanner,
wherein the reflective optical unit includes a holographic diffraction grating.
